(19) United States
(12) Patent Application Publication
(10) Pub. No.: US 2023/0189082 A1
(43) Pub. Date: Jun. 15, 2023

(54) NON-ORTHOGONAL AND ORTHOGONAL RESERVATION SIGNALS

(71) Applicant: QUALCOMM Incorporated, San Diego, CA (US)

(72) Inventors: Stelios STEFANATOS, San Diego, CA (US); Arthur GUBESKYS, San Diego, CA (US); Shuanshuan WU, San Diego, CA (US)

(21) Appl. No.: 17/995,943

(22) PCT Filed: Jun. 23, 2021
(86) PCT No.: PCT/US2021/038760

§ 371 Date: Oct. 11, 2022

(30) Foreign Application Priority Data
Jun. 24, 2020 (GR) 20200100367
Jun. 24, 2020 (GR) 20200100372

(51) Int. Cl. H04W 28/26; H04W 72/0446; H04W 72/0453

(52) U.S. Cl. CPC H04W 28/26; H04W 72/0446; H04W 72/0453

(57) ABSTRACT

Certain aspects of the present disclosure provide techniques for sidelink communications in an unlicensed spectrum. A method that may be performed by a first device includes sensing that an unlicensed frequency band is idle, the unlicensed frequency band consisting of a plurality of subchannels. The method also includes, in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period.

### CROSS-REFERENCE TO RELATED APPLICATION(S)

This application claims benefit of and priority to Greek Patent Application No. 20200100367, filed Jun. 24, 2020, and to Greek Patent Application No. 20200100372, filed Jun. 24, 2020, both of which are hereby assigned to the assignee hereof and hereby expressly incorporated by reference herein in their entirety as if fully set forth below and for all applicable purposes.

### INTRODUCTION

Aspects of the present disclosure relate to wireless communications, and more particularly, to techniques for reserving intervals of time for wireless communication between certain devices.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly.

Certain aspects relate to a first device comprising a memory and a processor coupled to the memory. The processor and the memory are configured to sense that an unlicensed frequency band is idle, the unlicensed frequency band consisting of a plurality of subchannels. The processor and the memory are also configured to, in response to sensing that the unlicensed frequency band is idle, transmit at least one of a data signal or a reservation signal during an entire duration of a time period over one or more subchannels of the plurality of subchannels, at least one of the data signal or the reservation signal reserving the unlicensed frequency band during the time period, wherein the transmission of the at least one of the data signal or the reservation signal during the entire time period comprises transmission of the reservation signal for at least a portion of the time period over less than all of the plurality of subchannels.

A first device of a plurality of devices, comprising a memory and a processor coupled to the memory. The processor and the memory are configured to receive wireless signaling within a time period over at least one subchannel of a plurality of subchannels in an unlicensed frequency band, the wireless signaling comprising: a reservation signal from a second device of the plurality of devices, the first device having an indication of a characteristic of the reservation signal stored thereon, the reservation signal reserving the unlicensed frequency band during the time period; and a data signal from a third device of the plurality of devices. The processor and the memory are also configured to filter the reservation signal from the wireless signaling based on the characteristic of the reservation signal.

Certain aspects relate to a method of wireless communication. The method includes sensing, by a first device, that an unlicensed frequency band is idle, the unlicensed frequency band consisting of a plurality of subchannels. The method also includes, in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels.

Certain aspects relate to a method of wireless communication. The method includes receiving, by a first device of a plurality of devices, wireless signaling within a time period over at least one subchannel of a plurality of subchannels in an unlicensed frequency band, the wireless signaling comprising: a reservation signal from a second device of the plurality of devices, the first device storing an indication of a characteristic of the reservation signal, the reservation signal reserving the unlicensed frequency band during the time period; and a data signal from a third device of the plurality of devices. The method also includes filtering, by the first device, the reservation signal from the wireless signaling based on the characteristic of the reservation signal.

Certain aspects relate to an apparatus for wireless communication. In some examples, the apparatus includes means for sensing that an unlicensed frequency band is idle, the unlicensed frequency band consisting of a plurality of subchannels. In some examples, the apparatus includes, in response to sensing that the unlicensed frequency band is idle, means for transmitting at least one of a data signal or a reservation signal during an entire duration of a time period over one or more subchannels of the plurality of subchannels, wherein the at least one of the data signal or the reservation signal is configured to reserve the unlicensed frequency band during the time period, wherein transmitting the at least one of the data signal or the reservation signal during the entire duration of the time period comprises transmitting the reservation signal for at least a portion of the time period over less than all of the plurality of subchannels.

Certain aspects relate to a first apparatus for wireless communication. In some examples, the first apparatus includes means for receiving wireless signaling within a time period over at least one subchannel of a plurality of subchannels in an unlicensed frequency band, the wireless signaling comprising: a reservation signal from a second apparatus of the plurality of apparatus', the first apparatus storing an indication of a characteristic of the reservation signal, wherein the reservation signal is configured to reserve the unlicensed frequency band during the time period. In some examples, the apparatus includes means for filtering, by the first apparatus, the reservation signal from the wireless signaling based on the characteristic of the reservation signal.

Certain aspects relate to a non-transitory computer-readable storage medium that stores instructions that when executed by a processor of an apparatus cause the apparatus to perform a method for wireless communication. In some examples, the method includes sensing, by a first device, that an unlicensed frequency band is idle, the unlicensed frequency band consisting of a plurality of subchannels. The method also includes, in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels.

Certain aspects relate to a non-transitory computer-readable storage medium that stores instructions that when executed by a processor of an apparatus cause the apparatus to perform a method for wireless communication. In some examples, the method includes receiving, by a first device of a plurality of devices, wireless signaling within a time period over at least one subchannel of a plurality of subchannels in an unlicensed frequency band, the wireless signaling comprising: a reservation signal from a second device of the plurality of devices, the first device storing an indication of a characteristic of the reservation signal, the reservation signal reserving the unlicensed frequency band during the time period; and a data signal from a third device of the plurality of devices. In some examples, the method includes filtering, by the first device, the reservation signal from the wireless signaling based on the characteristic of the reservation signal.

Certain aspects relate to a method of wireless communication. In some examples, the method includes determining, by a first user equipment (UE) of a plurality of UEs, that a frequency band is idle. In some examples, the method includes, in response to determining that the frequency band is idle, transmitting, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

Certain aspects relate to an apparatus for wireless communication. In some examples, the apparatus includes a processor and a memory. In some examples, the processor and the memory are configured to determine that a frequency band is idle transmit. In some examples, the processor and memory are configured to, in response to determining that the frequency band is idle, transmit, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

Certain aspects relate to an apparatus for wireless communication. In some examples, the apparatus includes means for determining, by a first user equipment (UE) of a plurality of UEs, that a frequency band is idle. In some examples, the apparatus includes means for transmitting, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

Certain aspects relate to a non-transitory computer-readable storage medium that stores instructions that when executed by a processor of an apparatus cause the apparatus to perform a method for wireless communication. In some examples, the method includes determining that a frequency band is idle. In some examples, the method includes, in response to determining that the frequency band is idle, transmitting a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

Certain aspects relate to a method of wireless communication. In some examples, the method includes receiving, by a first user equipment (UE) of a plurality of UEs, wireless signaling within a first time period over a subchannel of a plurality of subchannels in a frequency band, the wireless signal comprising: a reservation signal from a second UE of the plurality of UEs, the first UE preconfigured with a content of the reservation signal, the reservation signal indicating to one or more other wireless devices that the frequency band is busy during the first time period, wherein the plurality of UEs wirelessly communicate over the frequency band during the first time period; and a data signal from a third UE of the plurality of UEs. In some examples, the method includes filtering, by the first UE, the reservation signal from the wireless signaling using the content of the reservation signal.

Certain aspects relate to an apparatus for wireless communication. In some examples, the apparatus includes a processor and a memory. In some examples, the processor and the memory are configured to receive wireless signaling within a first time period over a subchannel of a plurality of subchannels in a frequency band, the wireless signal comprising: a reservation signal from a second UE of the plurality of UEs, the first UE preconfigured with a content of the reservation signal, the reservation signal indicating to one or more other wireless devices that the frequency band is busy during the first time period, wherein the plurality of UEs wirelessly communicate over the frequency band during the first time period; and a data signal from a third UE of the plurality of UEs. In some examples, the processor and the memory are configured to filter the reservation signal from the wireless signaling using the content of the reservation signal.

Certain aspects relate to an apparatus for wireless communication. In some examples, the apparatus includes means for receiving, by a first user equipment (UE) of a plurality of UEs, wireless signaling within a first time period over a subchannel of a plurality of subchannels in a frequency band, the wireless signal comprising: a reservation signal from a second UE of the plurality of UEs, the first UE preconfigured with a content of the reservation signal, the reservation signal indicating to one or more other wireless devices that the frequency band is busy during the first time period, wherein the plurality of UEs wirelessly communicate over the frequency band during the first time period; and a data signal from a third UE of the plurality of UEs. In some examples, the apparatus includes means for filtering, by the first UE, the reservation signal from the wireless signaling using the content of the reservation signal.

Certain aspects relate to a non-transitory computer-readable storage medium that stores instructions that when executed by a processor of an apparatus cause the apparatus to perform a method for wireless communication. In some examples, the method includes receiving, by a first user equipment (UE) of a plurality of UEs, wireless signaling within a first time period over a subchannel of a plurality of subchannels in a frequency band, the wireless signal comprising: a reservation signal from a second UE of the plurality of UEs, the first UE preconfigured with a content of the reservation signal, the reservation signal indicating to one or more other wireless devices that the frequency band is busy during the first time period, wherein the plurality of UEs wirelessly communicate over the frequency band during the first time period; and a data signal from a third UE of the plurality of UEs. In some examples, the method includes filtering, by the first UE, the reservation signal from the wireless signaling using the content of the reservation signal.

Certain aspects relate to a method of wireless communication. In some examples, the method includes determining, by a first user equipment (UE) of a plurality of UEs, that a frequency band is idle. In some examples, the method includes, in response to determining that the frequency band is idle, transmitting, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

Certain aspects relate to an apparatus for wireless communication. In some examples, the apparatus includes a processor and a memory. In some examples, the processor and the memory are configured to determine, by a first user equipment (UE) of a plurality of UEs, that a frequency band is idle. In some examples, the processor and the memory are configure to, in response to determining that the frequency band is idle, transmit, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

Certain aspects relate to an apparatus for wireless communication. In some examples, the apparatus includes means for determining, by a first user equipment (UE) of a plurality of UEs, that a frequency band is idle. In some examples, the apparatus includes, in response to determining that the frequency band is idle, means for transmitting, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

Certain aspects relate to a non-transitory computer-readable storage medium that stores instructions that when executed by a processor of an apparatus cause the apparatus to perform a method for wireless communication. In some examples, the method includes determining, by a first user equipment (UE) of a plurality of UEs, that a frequency band is idle. In some examples, the method includes, in response to determining that the frequency band is idle, transmitting, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of two example user equipment (UEs), in accordance with certain aspects of the present disclosure.

FIG. 3 is a diagram conceptually illustrating an example of a first UE communicating with one or more other UEs according to aspects of the present disclosure.

FIG. 4 is a diagram illustrating an example frame format, in accordance with certain aspects of the present disclosure.

FIG. 5 is a schematic diagram illustrating an example model of multiple wireless devices operating in an unlicensed spectrum, in accordance with certain aspects of the present disclosure.

FIG. 6 is a signal diagram illustrating an example model of communication, by the wireless devices of FIG. 5, over a frequency band of an unlicensed spectrum, in accordance with certain aspects of the present disclosure.

FIG. 7 is a block diagram conceptually illustrating a frequency band of an unlicensed spectrum within a time window, in accordance with certain aspects of the present disclosure.

FIG. 8 is a schematic diagram illustrating an example technique for recovering a data signal using the known reservation signal, in accordance with certain aspects of the present disclosure.

FIG. 9 is a block diagram conceptually illustrating an example CV2X slot structure and an example reservation signal slot structure, in accordance with certain aspects of the present disclosure.

FIG. 10 is a block diagram illustrating an example CV2X window, in accordance with certain aspects of the present disclosure.

FIG. 11 is a block diagram illustrating an example CV2X window, in accordance with certain aspects of the present disclosure.

FIG. 12 is a flow diagram illustrating example operations for wireless communication, in accordance with certain aspects of the present disclosure.

FIG. 13 is a flow diagram illustrating example operations for wireless communication, in accordance with certain aspects of the present disclosure.

FIG. 14 illustrates a communications device that may include various components configured to perform operations for the techniques disclosed herein in accordance with aspects of the present disclosure.

FIG. 15 is a flow diagram illustrating example operations for wireless communication, in accordance with certain aspects of the present disclosure.

FIG. 16 illustrates a communications device that may include various components configured to perform operations for the techniques disclosed herein in accordance with aspects of the present disclosure.

FIG. 17 is a flow diagram illustrating example operations for wireless communication, in accordance with certain aspects of the present disclosure.

FIG. 18 is a flow diagram illustrating example operations for wireless communication, in accordance with certain aspects of the present disclosure.

FIG. 19 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for facilitating communications between wireless devices.

Due to scarcity of bandwidth in the licensed spectrum, certain classes or types of devices may not operate exclusively in the licensed spectrum. As such, it is possible that a class of devices (e.g., CV2X devices) may operate in bands of unlicensed spectrum. However, compatibility issues between one class of devices that operate in the unlicensed spectrum (e.g., CV2X devices) and other classes of devices that operate in the unlicensed spectrum (e.g., non-CV2X devices) may prevent, for example, CV2X devices from directly notifying (e.g., by a clear-to-send (CTS) signal) non-CV2X devices of a time window (e.g., a period of time) during which CV2X devices may communicate in and/or reserve the unlicensed spectrum. Thus, in a scenario where, for example, a CTS signal of a CV2X device is not understood as a CTS signal by a non-CV2X device, an option for reserving a time window for CV2X device communication is to continuously transmit, by a CV2X device, signals (e.g., reservation signals and/or data signals) over the frequency band corresponding to the unlicensed spectrum throughout the duration of the time window. For example, the entire duration of the time window, meaning for the entire period of time of the time window without periods of time where there is no transmission of such signals. It should be noted that the techniques discussed herein are not limited to CV2X devices, and may be used for other suitable classes/types of devices, such as used for sidelink communications between wireless communication devices.

For example, techniques described herein may relate to communicating over a frequency band of unlicensed spectrum using time-division multiple access (TDMA) techniques to partition use of the frequency band in time into a first time window and a second time window (e.g., the pair of which may recur periodically). In some examples, a first group of wireless devices (e.g., one or more CV2X devices separated by grouping from another one or more CV2X devices) may communicate during the first time window, and a second group of wireless devices (e.g., one or more non-CV2X devices) may communicate during the second time window. The use of separate time windows provides the two different groups of devices with fair use of the frequency band.

In some examples, the first group of wireless devices may perform a listen-before-talk (LBT) sensing procedure prior to the first time window to determine whether the frequency band is idle. As used herein, the term “idle” means that energy as measured on the frequency band by a device (e.g., CV2X device, non-CV2X device, etc.) determining idleness is below a threshold level. As used herein, the term “busy” means that energy as measured on the frequency band by the device determining idleness is above the threshold level. Such energy may be due to noise or signals within the frequency band.

If the frequency band is determined to be idle, the first group of wireless devices may begin transmitting data or reservation signals (e.g., any signals specifically for reserving the frequency band and not carrying data) at the start of the first window. The data and reservation signals may indicate to the second group of wireless devices that the frequency band is busy throughout the duration of the first window should the second group of wireless devices attempt to perform an LBT procedure to try to communicate on the frequency band during the first window. Accordingly, the second group of wireless communication devices will not communicate during the first time window. Once the first time window ends, the second time window begins, and the first group of wireless devices cease communications. This allows the second group of devices to communicate during the second time window by performing an LBT procedure. In one example, the first group of wireless devices can impose TDMA-based partitions in time that allow for use of the frequency band between the first group and the second group of wireless devices.

In certain aspects, the first group may utilize frequency-division multiplexing (FDM) to communicate data signals and/or reservation signals over the same frequency band at the same time. For example, a data signal may be transmitted over a first subchannel of the frequency band, while a reservation signal may be transmitted over a second subchannel of the frequency band during the same time period. Such examples may be referred to as “orthogonal” communications of data signals and reservation signals.

In certain aspects, a data signal may be transmitted over a first subchannel of the frequency band, while a reservation signal may also be transmitted over the first subchannel of the frequency band during the same time period. Such examples may be referred to as “non-orthogonal” communications of data signals and reservation signals.

It should be noted that though certain aspects are described with respect to CV2X devices and communication in the unlicensed band, it can be appreciated that the aspects may similarly be applicable to other scenarios, other wireless communication devices (e.g., base stations (BSs) and user equipment (UE) as described herein, as well as any other suitable equivalents thereof), and any other types of communications (e.g., sidelink communications) in an unlicensed band, communications (e.g., sidelink communications) in a licensed band, etc.

Techniques discussed herein allow for CV2X devices to share communication in an unlicensed band with other devices operating in the same unlicensed band by transmitting orthogonal and/or non-orthogonal reservation signals for limited durations of time, thereby enhancing device coexistence. Further, such techniques also account for potential unavailability of the unlicensed band due to communication by other devices, such as through the use of LBT as discussed herein.

Accordingly, the techniques herein lead to improved reliability and accessibility of communications in unlicensed spectrum, by transmitting orthogonal and/or non-orthogonal reservation signals indicating a reserved time window for communications between CV2X devices and separate windows of time for communication between non-CV2X devices. Thus, these techniques can help improve latency, by reducing the time CV2X devices have to wait to communicate over the unlicensed band. These techniques can further improve data decoding reliability, by allowing devices to communicate during common time windows, and thus be able to decode transmissions during the common time windows.

Such techniques may be used, for example, in sidelink communications between wireless communication devices. In other examples, the wireless communication devices may include cellular vehicle-to-everything (CV2X) devices. It should be noted that though certain aspects are described with respect to CV2X devices and communication in the unlicensed band, it can be appreciated that the aspects may similarly be applicable to other scenarios, such as any communications (e.g., sidelink communications) in an unlicensed band, communications (e.g., sidelink communications) in a licensed band, etc.

An unlicensed band refers to any frequency band(s) that are not subject to licensed use under regulatory practice, such that they are open to use by any devices, and not just devices that have a license to use the particular frequency band(s).

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the international telecommunications union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The following description provides examples of techniques for transmitting non-orthogonal or orthogonal reservation signals, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a subchannel (e.g., a group of more than one subcarriers), a frequency band, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

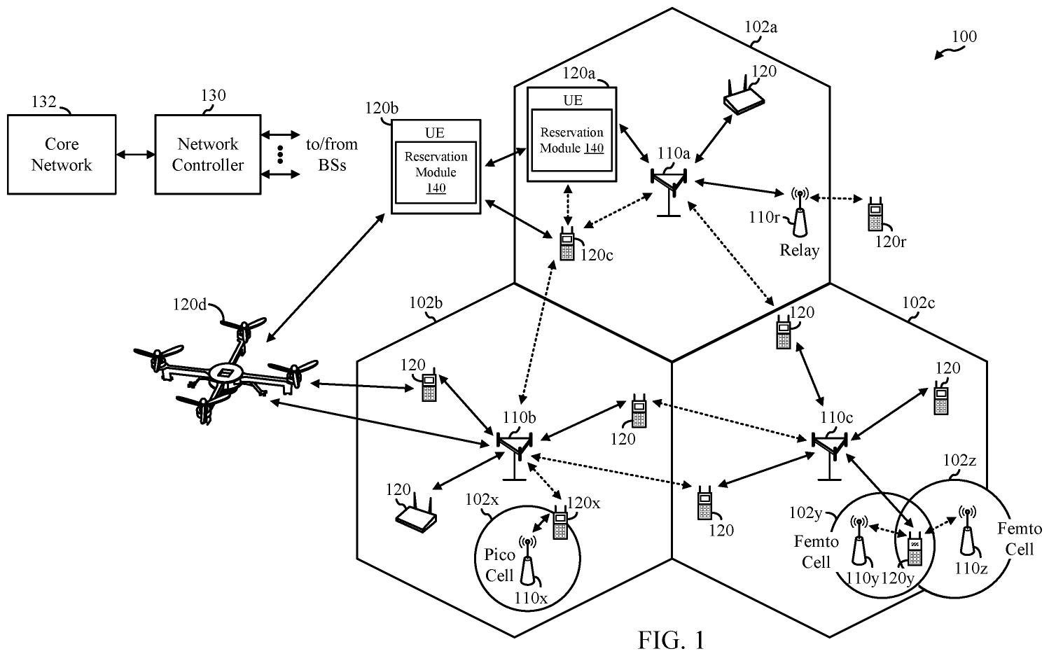

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS 110 may support one or multiple cells. A network controller 130 may couple to a set of BSs 110 and provide coordination and control for these BSs 110 (e.g., via a backhaul).

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. In one example, a quadcopter, drone, or any other unmanned aerial vehicle (UAV) or remotely piloted aerial system (RPAS) 120d may be configured to function as a UE. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

In some examples of the wireless communication network 100, sidelink communication may be established between UEs and/or BSs without necessarily relying on UE ID or control information from a base station. For example, UE 120a may initiate a sidelink communication with UE 120b without relying on a direct connection with a base station (e.g., base station 110a), such as if the UE 120b is outside of cell 102a's range. Any of the UEs illustrated in FIG. 1 may function as a scheduling entity or a primary sidelink device, while the other UEs may function as a subordinate entity or a non-primary (e.g., secondary) sidelink device. Further, the UEs may be configured to transmit synchronization signaling for sidelink as described throughout the disclosure. Accordingly, one or more of the UEs may function as a scheduling entity in a device-to-device (D2D), peer-to-peer (P2P), or vehicle-to-vehicle (V2V) network, and/or in a mesh network to initiate and/or schedule synchronization signaling.

According to certain aspects, UEs 120 may be configured for transmitting non-orthogonal reservation signals over a wireless interface, such as in one or more unlicensed frequency bands. As shown in FIG. 1, a first UE 120a and a second UE 120b each include a reservation module 140. The reservation module 140 may be configured to determine that a frequency band is idle. If the frequency band is determined to be idle, the reservation module 140 may also be configured to transmit a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

In certain aspects, UEs 120 may be configured to perform interference cancelation to eliminate any interference caused by transmission of a reservation signal by another UE 120. For example, the reservation module 140 may be configured to receive wireless signaling within a first time period over a subchannel of a plurality of subchannels in a frequency band, the wireless signal comprising: data and a reservation signal transmitted by another UE. In this case, the receiving UE 120 may be preconfigured with the content of the reservation signal. The reservation module 140 may be configured to filter the reservation signal from the data of the wireless signaling using the content of the reservation signal.

In certain aspects, the reservation module 140 may be configured to sense that an unlicensed frequency band is idle, the unlicensed frequency band consisting of a plurality of subchannels. In certain aspects, the reservation module 140 may be configured to, in response to sensing that the unlicensed frequency band is idle, transmit at least one of a data signal or a reservation signal during an entire duration of a time period over one or more subchannels of the plurality of subchannels, at least one of the data signal or the reservation signal reserving the unlicensed frequency band during the time period, wherein the transmission of the at least one of the data signal or the reservation signal during the entire time period comprises transmission of the reservation signal for at least a portion of the time period over less than all of the plurality of subchannels.

In certain aspects, the reservation module 140 may be configured to receive wireless signaling within a time period over at least one subchannel of a plurality of subchannels in an unlicensed frequency band, the wireless signaling comprising: a reservation signal from a second device of the plurality of devices, the first device having an indication of a characteristic of the reservation signal stored thereon, the reservation signal reserving the unlicensed frequency band during the time period; and a data signal from a third device of the plurality of devices. In some examples, the reservation module may be configured to filter the reservation signal from the wireless signaling based on the characteristic of the reservation signal.

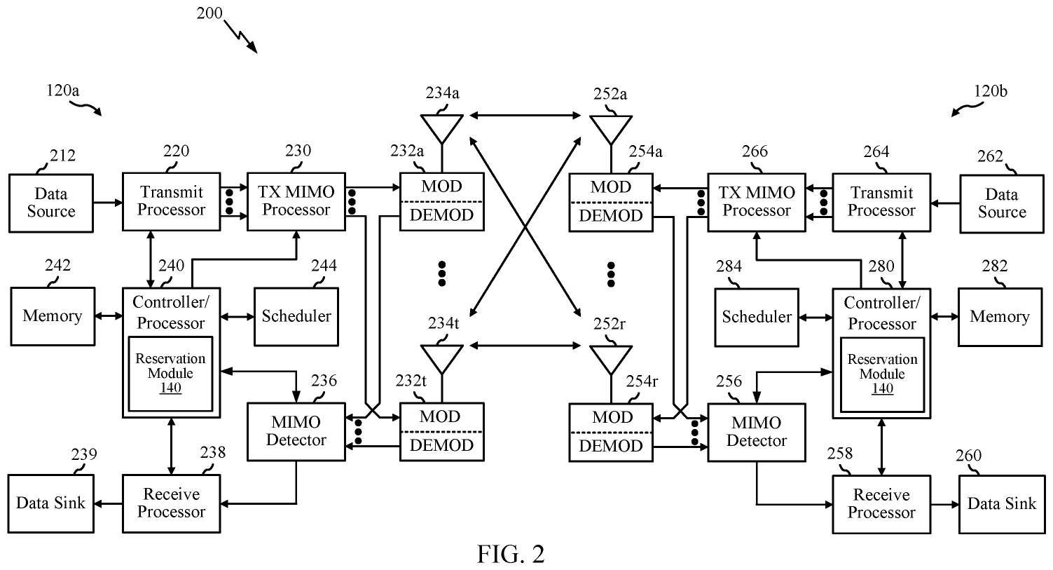

FIG. 2 illustrates example components 200 of a first UE 120a and a second UE 120b (e.g., in the wireless communication network 100 of FIG. 1), which may be used to implement aspects of the present disclosure.

At the first UE 120a, a transmit processor 220 may receive data from a data source 212 and control information from a controller/processor 240. The control information may be for the physical broadcast channel (PBCH), physical sidelink broadcast channel (PSBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), physical sidelink shared channel (PSSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators (MODs) in transceivers 254a-254r (e.g., for SC-FDM, etc.), and transmitted to the BS 110a. At the BS 110a, the uplink signals from the UE 120a may be received by the antennas 234, processed by the modulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for the first UE 120a and second UE 120b, respectively. A scheduler 244/284 may schedule UEs for data transmission/reception.

Antennas 252, processors 266, 258, 264, and/or controller/processor 280 of the second UE 120b and/or antennas 234, processors 220, 230, 238, and/or controller/processor 240 of the first UE 120a may be used to perform the various techniques and methods described herein. For example, as shown in FIG. 2, the controller/processor of both UEs includes a reservation module 140 that may be configured to determine that a frequency band is idle (e.g., sense whether interference exists, or a degree to which interference exists on a frequency band). If the frequency band is determined to be idle, the reservation module 140 may also be configured to transmit a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

In certain aspects, UEs 120 may be configured to perform interference cancelation to eliminate any interference caused by transmission of a reservation signal by another UE 120. For example, the reservation module 140 may be configured to receive wireless signaling within a first time period over a subchannel of a plurality of subchannels in a frequency band, the wireless signal comprising: data and a reservation signal transmitted by another UE. In this case, the receiving UE 120 may be preconfigured with the content of the reservation signal. The reservation module 140 may be configured to filter the reservation signal from the data of the wireless signaling using the content of the reservation signal.

In certain aspects, the reservation module 140 may be configured to sense that an unlicensed frequency band is idle, the unlicensed frequency band consisting of a plurality of subchannels. In certain aspects, the reservation module 140 may be configured to, in response to sensing that the unlicensed frequency band is idle, transmit, by the UE, at least one of a data signal or a reservation signal during an entire time period (e.g., the full duration of the time period without a gap) over one or more subchannels of the plurality of subchannels, wherein the at least one of the data signal or the reservation signal is configured to reserve the unlicensed frequency band during the time period, wherein to transmit the at least one of the data signal or the reservation signal during the entire time period comprises to transmit the reservation signal for at least a portion of the time period over less than all of the plurality of sub channels.

In certain aspects, the reservation module 140 may be configured to receive wireless signaling within a time period over at least one subchannel of a plurality of subchannels in an unlicensed frequency band, the wireless signaling comprising: a reservation signal from a second device of the plurality of devices, the first device having an indication of a characteristic of the reservation signal stored thereon, the reservation signal reserving the unlicensed frequency band during the time period; and a data signal from a third device of the plurality of devices.

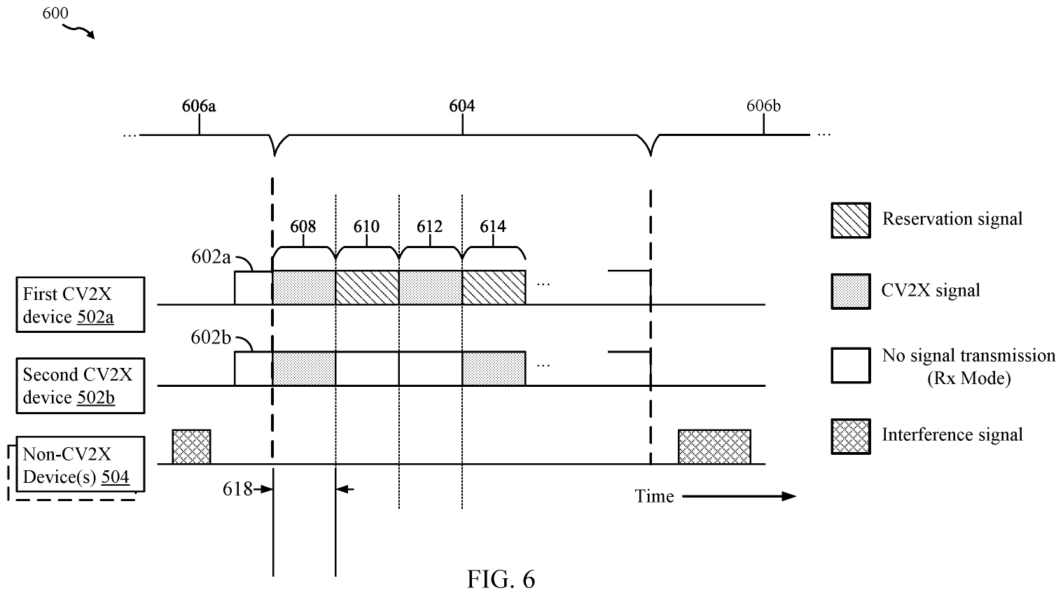

In some examples, the reservation module may be configured to filter the reservation signal from the wireless signaling based on the characteristic of the reservation signal. For example, a characteristic of a reference signal may include one or more of: (i) at least one subchannel over which the reservation signal is transmitted, (ii) a portion of the at least one subchannel over which the reservation signal is transmitted, (iii) a resource element (RE) occupied by the reservation signal, and one or more symbols within the RE, (iv) a waveform of the reservation signal, or (v) a time and frequency pattern occupied by the reservation signal (e.g., a synchronous/asynchronous time and frequency pattern as shown in FIGS. 6, 7, 10 and 11). In certain aspects, the indication comprises one or more of an index or a mapping corresponding to the characteristic of the reservation signal. For example, a UE may store one or more indications each corresponding to a characteristic of the one or more characteristics.

NR may utilize orthogonal frequency division multiplexing (OFDM) with a cyclic prefix (CP). NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

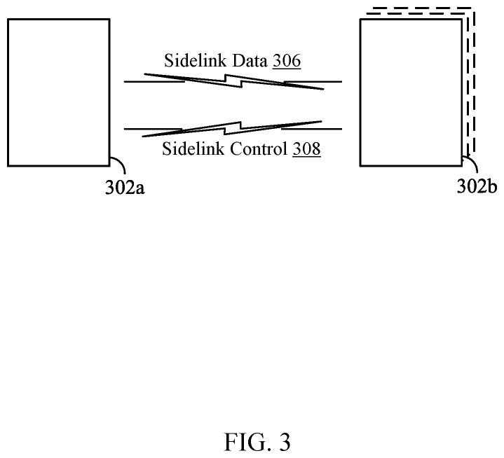

FIG. 3 is a diagram conceptually illustrating a sidelink communication between a first UE 302a and one or more second UEs 302b (collectively, “UEs 302”). In various examples, any one of the first UE 302a and the second UE 302b may correspond to a UE (e.g., UE 120a or UE 120b of FIGS. 1 and 2) or other suitable node in the wireless communication network 100.

In some examples, the first UE 302a and the second UE 302b may utilize sidelink signals for direct D2D communication. The D2D communication may use the downlink/uplink wireless wide area network (WWAN) spectrum and/or an unlicensed spectrum. The D2D communication may use one or more sidelink channels, such as a physical sidelink broadcast channel (PSBCH), a physical sidelink discovery channel (PSDCH), a physical sidelink shared channel (PSSCH), and a physical sidelink control channel (PSCCH) over these spectrums. D2D communication may be through a variety of wireless D2D communications systems, such as for example, FlashLinQ, WiMedia, Bluetooth, ZigBee, Wi-Fi based on the IEEE 802.11 standard, LTE, or NR.

Sidelink signals may include sidelink data 306 (i.e., sidelink traffic) and sidelink control information 308. Broadly, the first UE 302a and one or more second UEs 302b may communicate sidelink data 306 and sidelink control information 308 using one or more data channels and control channels. In some aspects, data channels include the PSSCH, and control channels include the PSCCH and/or physical sidelink feedback channel (PSFCH).

Sidelink control information 308 may include a source transmit signal (STS), a direction selection signal (DSS), and a destination receive signal (DRS). The DSS/STS may provide for a UE 302 (e.g., 302a, 302b) to request a duration of time to keep a sidelink channel available for a sidelink signal; and the DRS may provide for the UE 302 to indicate the availability of the sidelink channel, e.g., for a requested duration of time. Accordingly, the first UE 302a and the second UE 302b may negotiate the availability and use of sidelink channel resources prior to communication of sidelink data 306 information.

In some configurations, any one or more of the first UE 302a or the second UE 302b may periodically/aperiodically transmit or broadcast sidelink synchronization signaling to increase chances of detection by another UE or BS. For example, one or more of the first UE 302a and the second UE 302b may periodically/aperiodically transmit sidelink synchronization signals in one or more slots of specific time windows. In some examples, the UEs are preconfigured with information indicating the location and duration of the time window within a frame (e.g., which slots within the frame, and how many). In some aspects, the UEs may be configured with the location and duration of the time window via messaging between UEs or messaging received from a BS (e.g., radio resource control (RRC) signaling).

The channels or carriers illustrated in FIG. 3 are not necessarily all of the channels or carriers that may be utilized between a first UE 302a and a second UE 302b in a sidelink communication, and those of ordinary skill in the art will recognize that other channels or carriers may be utilized in addition to those illustrated, such as other data, control, and feedback channels.

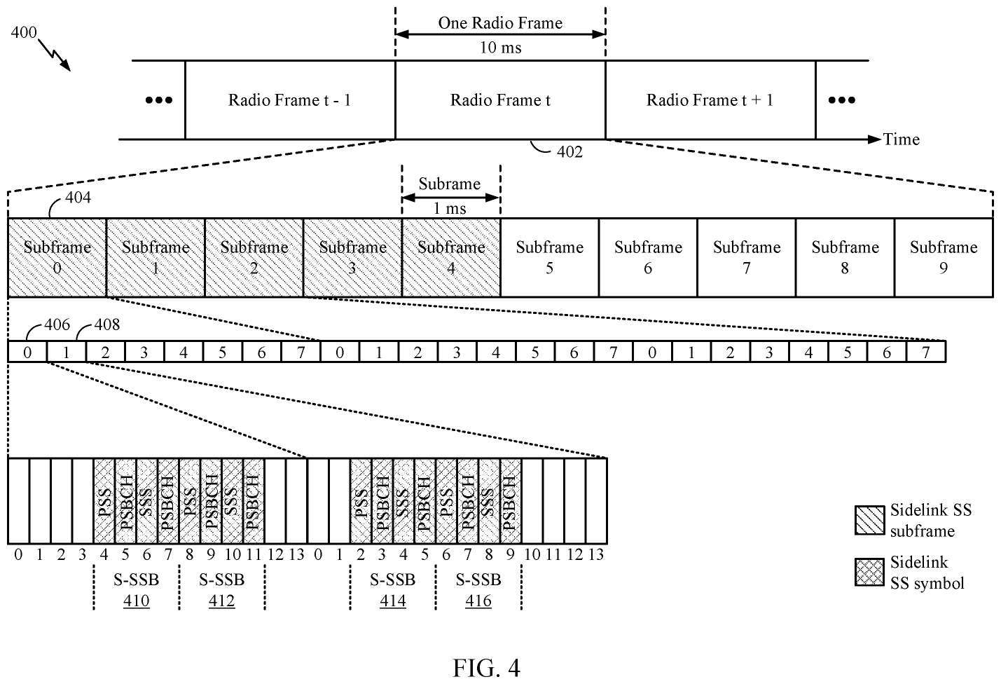

FIG. 4 is a diagram showing an example of a frame format 400. The transmission timeline for each data transmission and reception may be partitioned into units of radio frames 402. In NR, the basic transmission time interval (TTI) may be referred to as a slot. In NR, a subframe may contain a variable number of slots (e.g., 1, 2, 4, 8, 16, . . . , N slots) depending on the subcarrier spacing (SCS). NR may support a base SCS of 15 KHz and other SCS may be defined with respect to the base SCS (e.g., 30 kHz, 60 kHz, 120 kHz, 240 kHz, etc.). In the example shown in FIG. 4, the SCS is 120 kHz. As shown in FIG. 4, the subframe 404 (subframe 0) contains 8 slots (slots 0, 1, . . . , 7) with a 0.125 ms duration. The symbol and slot lengths scale with the subcarrier spacing. Each slot may include a variable number of symbol (e.g., OFDM symbols) periods (e.g., 7 or 14 symbols) depending on the SCS. For the 120 kHz SCS shown in FIG. 4, each of the slot 406 (slot 0) and slot 408 (slot 1) includes 14 symbol periods (slots with indices 0, 1, . . . , 13) with a 0.25 ms duration.

In sidelink, a sidelink synchronization signal block (S-SSB), referred to as the SS block or SSB, is transmitted. The SSB may include a primary SS (PSS), a secondary SS (SSS), and/or a two symbol physical sidelink broadcast channel (PSBCH). In some examples, the SSB can be transmitted up to sixty-four times with up to sixty-four different beam directions. The up to sixty-four transmissions of the SSB are referred to as the SS burst set. SSBs in an SS burst set may be transmitted in the same frequency region, while SSBs in different SS bursts sets can be transmitted in different frequency regions.

In the example shown in FIG. 4, in the subframe 404, SSB is transmitted in each of the slots (slots 0, 1, . . . , 7). In the example shown in FIG. 4, in the slot 406 (slot 0), an SSB 410 is transmitted in the symbols 4, 5, 6, 7 and an SSB 412 is transmitted in the symbols 8, 9, 10, 11, and in the slot 408 (slot 1), an SSB 414 is transmitted in the symbols 2, 3, 4, 5 and an SSB 416 is transmitted in the symbols 6, 7, 8, 9, and so on. The SSB may include a primary SS (PSS), a secondary (SSS), and a two symbol physical sidelink broadcast channel (PSBCH). The PSS and SSS may be used by UEs to establish sidelink communication (e.g., transmission and/or reception of data and/or control channels). The PSS may provide half-frame timing, the SS may provide cyclic prefix (CP) length and frame timing. The PSBCH carries some basic system information, such as system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), and other system information (OSI) can be transmitted on a physical sidelink shared channel (PSSCH) in certain subframes.

In certain aspects, cellular vehicle to everything (CV2X) communications in a licensed spectrum are synchronous in the sense that transmissions are generally aligned in terms of the time and frequency resources illustrated in FIG. 4. In certain aspects, the allocation of frames, subframes, slots, etc. are provisioned for by network protocols and rules that apply to wireless communications in the licensed spectrum. For example, establishing time synchronization when operating in a licensed spectrum, which include: (i) using global navigation satellite system (GNSS) as a common time reference (e.g., current coordinated universal time (UTC)), from which a UE derives frame and slot boundaries; and (ii) using an in-band signaling method, by which transmissions originating from both UEs and BSs are scheduled to avoid collision.

However, as discussed, it is possible that CV2X communications may operate in one or more frequency bands of the unlicensed spectrum. Thus, in some examples, GNSS-based synchronization between CV2X devices (e.g., UEs and/or BSs) may be applied in the unlicensed spectrum. In certain aspects, GNSS-based synchronization between CV2X devices may be achieved without signaling overhead (e.g., without synchronization signaling). However, if GNSS-based synchronization is not available or is undesirable due to, for example, reliability issues, it may be preferable that synchronization between CV2X devices is established via periodic, in-band broadcast signaling of synchronization signals.

Thus, an in-band signaling procedure for CV2X operations in an unlicensed spectrum may facilitate communication accessibility, reliability and throughput.

### Example Techniques for Time-Division Multiple Access (TDMA) Based Communications in Unlicensed Bands

Aspects of the present disclosure provide for implementing TDMA-based techniques and frame formats to support CV2X communications in an unlicensed spectrum. In one example, one or more CV2X devices utilize periodic intervals for communication (e.g., the TDMA aspect), where time is partitioned into “CV2X windows” and “non-CV2X windows” that may recur periodically. In this example, the one or more CV2X devices may communicate during periodic CV2X windows in an unlicensed spectrum, while refraining from communication during non-CV2X windows to allow one or more other wireless devices an opportunity to transmit and receive data. In certain aspects, within the CV2X windows, the one or more CV2X devices may communicate using aspects of the same frame format used in a licensed spectrum. That is, one or more CV2X devices may partition the CV2X window into slots as illustrated in FIG. 4. Though discussion is made with respect to dividing a CV2X window into slots, the CV2X window may be divided into any suitable time periods.

In certain aspects, the duration of the CV2X and non-CV2X windows may depend on where the communication system is deployed. For example, if a particular area has a relatively high amount of non-CV2X wireless communication traffic over the unlicensed spectrum, the CV2X windows may be reduced in time duration, and the non-CV2X windows may be increased in time duration. In another example, if a particular area has a relatively high number of CV2X devices, and/or a relatively high amount of wireless communication between the CV2X devices, CV2X windows may be increased in time duration, and the non-CV2X windows may be decreased in time duration.

In certain aspects, one or more non-CV2X devices are not designed for such a TDMA operation. Thus, the one or more CV2X devices may impose TDMA time partitioning (e.g., CV2X windows and non-CV2X windows) on the one or more non-CV2X devices. In certain aspects, such as to abide by regulatory requirements for unlicensed spectrum use, the imposition of TDMA operations by the one or more CV2X devices may include a listen-before-talk (LBT) procedure.

In some examples, one or more CV2X devices (e.g., a subset of the CV2X devices) may perform the LBT procedure prior to a scheduled or pre-configured CV2X window to determine whether a frequency band in the unlicensed spectrum is idle prior to communicating over the frequency band. If the subset of CV2X devices senses the frequency band idle, those CV2X devices may use a continuous transmit mode for the duration of the whole CV2X window, and transmit either data or a reservation signal over the whole or entire duration of the CV2X window without a gap (e.g., in each slot of the CV2X window). The continuous transmission by the subset of CV2X devices may be sensed by non-CV2X devices, which then refrain from communicating over the frequency band. Other CV2X devices may treat the frequency band as available for the remainder of the CV2X window, and may communicate with each other, such as using the slot format of FIG. 4.

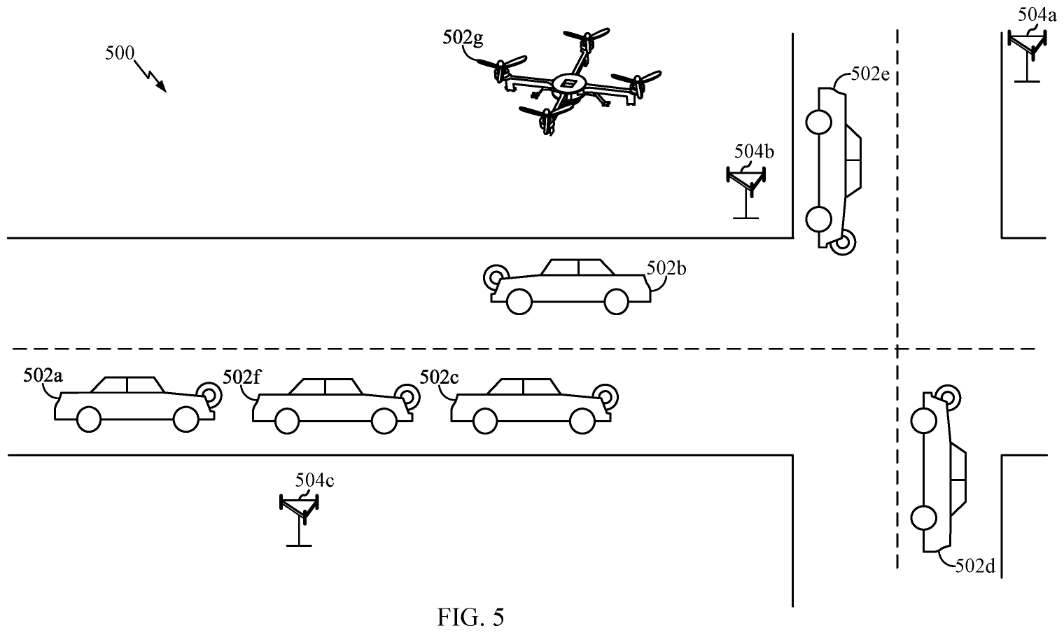

FIG. 5 is a schematic diagram illustrating an example network 500 of multiple CV2X devices operating in an unlicensed spectrum. In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g)— collectively referred to as CV2X devices 502) may operate in an unlicensed spectrum with other non-CV2X devices (e.g., non-CV2X devices 504a-504c— collectively referred to as non-CV2X devices 504).

In some examples, the first CV2X device 502a, the sixth CV2X device 502f, and the third CV2X device 502c may be part of a fleet. Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include devices on motorcycles, or carried by users (e.g., pedestrian, bicyclist, etc.), and other environments may include indoor environments such as offices, residential, or urban infrastructure (e.g., subways, trains, etc.) environments. The CV2X devices 502 may also include UEs (e.g., UE 120 of FIG. 1) and/or RSUs operated by a highway authority, and may be devices implemented on motorcycles or carried by users (e.g., pedestrian, bicyclist, etc.), or may be implemented on another aerial vehicle such as a helicopter or drone.

In this example, the first CV2X device 502a has been configured to serve as a reservation device for the duration of the whole window. That is, the first CV2X device 502a is configured to perform the LBT procedure prior to a scheduled or pre-configured CV2X window to determine whether a frequency band in the unlicensed spectrum is idle. Once the first CV2X device 502a senses the frequency band idle, the first CV2X device 502a may proceed to transmit either data or reservation signals over CV2X slots (e.g., slots illustrated in FIG. 4) within the window. If the frequency band is idle, the second CV2X device 502b may begin communicating data within the CV2X window as well. In some examples, the CV2X devices 502 may communicate sidelink data within the CV2X window as if they were operating under licensed spectrum conditions.

FIG. 6 is a signal diagram 600 illustrating an example model of communication, by the first CV2X device 502a and the second CV2X device 502b of FIG. 5, over a frequency band of an unlicensed spectrum shared with one or more non-CV2X devices 504. In this diagram, a time dimension is indicated on an x-axis of the model, and a frequency dimension is indicated on a y-axis of the signal diagram 600. However, it should be noted that the frequency resources used by each of the first CV2X device 502a, the second CV2X device 502b, and the non-CV2X devices 504 may be the same, different, or partially overlapping with one or more of the other of the first CV2X device 502a, the second CV2X device 502b, or the non-CV2X devices 504. In this example, first CV2X device 502a performs a first LBT procedure 602a and the second CV2X device 502b performs a second LBT procedure 602b, during a first non-CV2X window 606a prior to the start of a CV2X window 604. In certain aspects, the LBT procedures 602 are performed and then the CV2X window 604 begins without a gap between the LBT procedures 602 and the CV2X window 604. A second non-CV2X window 606b begins after the CV2X window 604. Although any suitable duration is contemplated by this disclosure, in one example, the LBT procedure 602 may last 25 microseconds (μs). At the time of the LBT procedures 602, the non-CV2X devices 504 are not transmitting data (e.g., neither of the CV2X devices 502 detect an interference signal). As such, the CV2X devices 502 may determine that the frequency band is idle because neither of the devices detect energy from signals from the one or more non-CV2X devices 504 on the unlicensed frequency band.

In this example, the first CV2X device 502a is serving as reservation device (e.g., the subset of CV2X devices that are to use a continuous transmit mode for the duration of the whole CV2X window 604), and accordingly, will transmit data over slots 618 in the CV2X window 604 (if it has data to transmit), or will transmit a reservation signal over slots 618 that the first CV2X device 502a does not transmit data over. For example, note that the first CV2X device 502a transmits a data signal in both a first slot 608 and a third slot 612 of the CV2X window 604. However, because the first CV2X device 502a has no data to transmit during a second slot 610 and a fourth slot 614, it will instead transmit a reservation signal. Here, because the first CV2X device 502a is a reservation device, it may function in a continuous transmit mode (e.g., continuing to transmit either CV2X data or reservation signals throughout the entire duration of the CV2X window 604) to prevent nearby non-CV2X devices 504 from creating interference on the unlicensed frequency band during the CV2X window 604.

In certain aspects, the second CV2X device 502b is not a reservation device, so it does not have to be in continuous transmit mode for the duration of the CV2X window 604. For example, the second CV2X device 502b may transmit a data signal during the first slot 608 and the fourth slot 614, and may be idle or receiving data during the second slot 610 and the third slot 612.

In some examples, data-bearing CV2X slots transmitted by a reservation device 502a may have no gap OFDM symbols (e.g., zero symbol gap). While gap symbols are generally used to provide a device with enough time to switch from a transmit mode to a receive mode, such a switch may be unnecessary for the reservation device 502a because it is always in transmit mode for the duration of a corresponding CV2X window 604. Thus, in the example shown, the first CV2X device 502a may fill any gap symbols with an arbitrary signal (e.g., random noise). Similarly, the reservation signals may be any suitable arbitrary signal and/or random noise.

The following solutions are provided to reduce or eliminate interference (from the perspective of non-CV2X devices) caused by signals transmitted by the reservation device 502a.

### Example Techniques for Non-Orthogonal Reservation and CV2X Signal Transmission

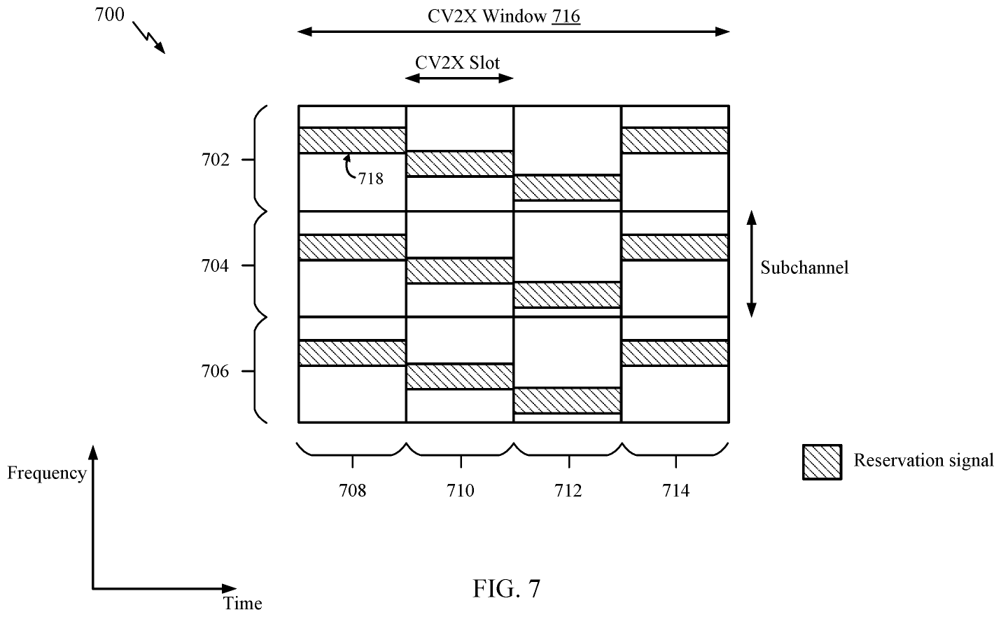

FIG. 7 is a block diagram conceptually illustrating a frequency band 700 of an unlicensed spectrum within a CV2X window 716. In this example, the CV2X window 716 is divided in frequency into three separate subchannels: a first subchannel 702, a second subchannel 704, and a third subchannel 706; and is divided in time into four slots: a first slot 708, a second slot 710, a third slot 712, and a fourth slot 714. Within the CV2X window 716, multiple CV2X devices (e.g., CV2X devices 502 of FIG. 5) may communicate, where one or more of the multiple CV2X devices 502 may be a reservation device configured to transmit reservation signals to prevent non-CV2X devices from communicating on the frequency band 700 during the CV2X window 716. Though CV2X window is shown with three subchannels and four slots, it should be understood that a CV2X window may have any suitable number of subchannels divided into any suitable number of time periods, such as slots.

In certain aspects, a reservation device (e.g., UE 120 of FIGS. 1 and 2, UE 302 of FIG. 3, or any of CV2X devices 502 of FIG. 5) may transmit a reservation signal over a portion (e.g., less than a whole bandwidth) of a subchannel, of one or more of the first subchannel 702, the second subchannel 704, or the third subchannel 706 in the frequency band 700. In this way, the reservation signal is structured such that interference to data communicated over the CV2X window 716 is reduced, because the reservation signal is transmitted over only a portion of the subchannel, thus not causing as much interference to the remainder of the subchannel other than the portion.

In some examples, the reservation signals may be wideband signals that are transmitted in all three subchannels 702-706 of the frequency band 700. In the example illustrated in FIG. 7, the reservation signals are transmitted over a portion of each of the three subchannels 702-706 of the frequency band 700. In certain aspects, if the reservation signals are transmitted over a portion of each of two or more subchannels in a single slot, the reservation signal of each of the two or more subchannels may be transmitted with a reduced power relative to any data that is also transmitted in the two or more subchannels. This is because the transmission power of the reservation signal is distributed across multiple subchannels. Thus, in such aspects, because the reservation signal is transmitted with a reduced power relative in a subchannel with respect to a data signal also transmitted in the subchannel, any interference caused by the reservation signal in the subchannel is relatively minor compared to interference that may be caused by a reservation signal transmitted at full power over only one subchannel.

In certain aspects, the reservation device 502 transmits a reservation signal over only a subset of resource elements (REs) 718 in each of the subchannels. Generally, an RE is defined as a minimum time-frequency resource assignable for communication, such as a minimum frequency range (e.g., one tone) during a minimum time range (e.g., one symbol). In certain aspects, a single RE may contain a single complex value representing data communicated from a physical channel or signal. For example, if a CV2X slot corresponding to a subchannel 0 contains 50 REs, a reservation signal transmitted over the CV2X slot may occupy less than 50 REs. In certain aspects, the reservation signal may occupy a single RE across multiple symbols in each CV2X slot. In some examples, the reservation signal may occupy a first minimum frequency resource (e.g., the frequency bandwidth of a single RE) of a first slot, and the reservation signal may occupy a second minimum frequency resource of a second slot. In some examples, the reservation signal may occupy a first minimum frequency resource of a first OFDM symbol of a first slot and a second minimum frequency resource of a second OFDM symbol of the first slot.

As shown in FIG. 7, the subset of REs 718 may form a pattern of REs 718 used in each CV2X slot 708-714 and subchannel 702-706. The pattern of REs 718 that a reservation signal occupies (shown using hatching in FIG. 7) within a particular subchannel 702-706 across slots 708-714 may be defined for each given slot by the offset from the lowest frequency value in the subchannel. Accordingly, as shown, each of subchannels 702-706 includes the same pattern of REs 718 relative to the lowest frequency of the given subchannel across slots 708-714. In this example, the pattern of REs 718 may be a pattern known by each of the CV2X devices that are communicating on the frequency band during the CV2X window 716. For example, each of the CV2X devices may be configured with the pattern by a BS (e.g., BS 110 of FIG. 1) or by the reservation device (e.g., another CV2X device). According to certain aspects, the pattern may be configured so that REs occupied by the reservation signal (shown using hatching in FIG. 7) do not interfere or collide with REs occupied by reference signals. That is, in certain aspects, for each slot and subchannel, the reservation signal may be patterned such that it does not interfere or collide with REs used for a demodulation reference signal (DMRS), or any other reference signals used by the CV2X devices.

While FIG. 7 illustrates one example reservation signal pattern, it is appreciated that any suitable pattern or asymmetric arrangement may be implemented. Accordingly, the REs occupied by the reservation signal may change between one or more slots and/or sub channels and/or OFDM symbols within a slot, or may be the same throughout all of the slots and/or subchannels in the CV2X window. Moreover, the number of REs occupied by the reservation signals may change between one or more slots and/or subchannels. For example, a reservation signal transmitted over slots in subchannel 0 may occupy 1 RE, while a reservation signal transmitted over slots in subchannel 1 may occupy 2 or more REs. In another example, a reservation signal may only occupy REs of subchannel 0 and subchannel 2 during slot 0, but another reservation signal may only occupy REs of subchannel 1 and subchannel 2 during slot 1.

### Example Techniques for Interference Cancelation

In some examples, the pattern of REs used for reservation signaling in each slot and subchannel is known by each of the CV2X devices in a deployment. Thus, in certain aspects, interference caused by reservation signaling can be at least partially removed (e.g., canceled) by a signal modulator/demodulator (e.g., the modulator/demodulator 232 of the first UE 120a of FIG. 2, and the modulator/demodulator (MODs) in transceiver 254 of the second UE 120b of FIG. 2). For example, if a first CV2X device receives both of: (i) a data signal from a second CV2X device, and (ii) a reservation signal from a reservation device, the first CV2X device may recover any lost data signaling by subtracting the known reservation signal from the data signal. Such subtracting may be referred to as “filtering.” Note that in order to cancel interference of a data signal caused by a reservation signal, the CV2X device may need to know the reservation signal as well as the channel over which the reservation signal was transmitted.

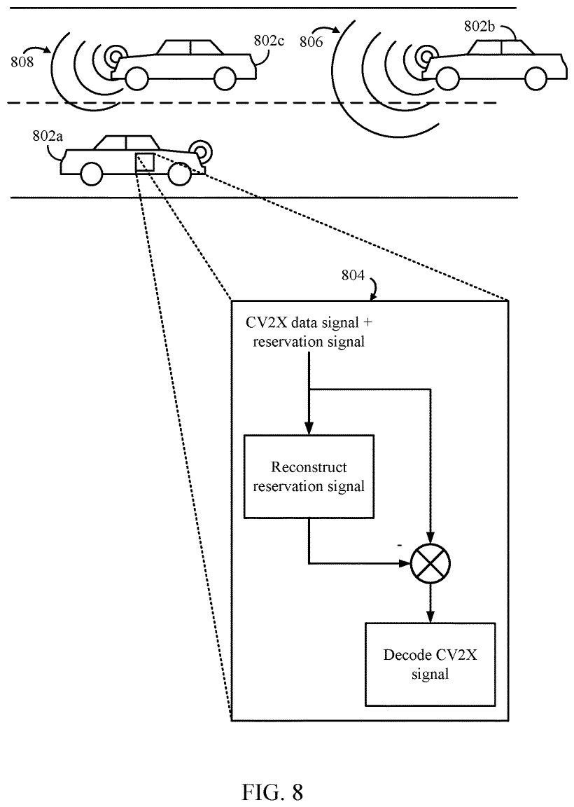

FIG. 8 is a schematic diagram illustrating an example technique for recovering (e.g., filtering) a data signal using a signal demodulator 804 and the known reservation signal by a first CV2X device 802a (e.g., UE 120 of FIGS. 1 and 2, UE 302 of FIG. 3, or any of CV2X devices 502 of FIG. 5) transmitted by a second CV2X device 802b (e.g., UE 120 of FIGS. 1 and 2, UE 302 of FIG. 3, or any of CV2X devices 502 of FIG. 5). Here, CV2X data 806 transmitted by the second CV2X device 802b may occupy the same resources (e.g., REs) as reservation signals 808 transmitted by a third CV2X device 802c (e.g., a reservation device) (e.g., UE 120 of FIGS. 1 and 2, UE 302 of FIG. 3, or any of CV2X devices 502 of FIG. 5). It should be noted that in some examples, the second CV2X device 802b may transmit both the CV2X data 806 and reservation signals 808 simultaneously over the same frequency resources. In this example, the first CV2X device 802a receives the CV2X data 806 and the reservation signal 808 over the same time and frequency resources (e.g., during the same slot and over the same subchannel).

In this example, the reservation signal 808 may interfere with the data signal 806. However, the first CV2X device 802a can reconstruct the reservation signal using a configured reservation signal pattern along with the received data 806 and reservation signals 808. In one example, the first CV2X device 802a may perform channel estimation using, for example, DMRS symbols included in the received reservation signal 808 to determine the channel over which the reservation signal 808 was communicated. The first CV2X device 802a may then reconstruct the reservation signal 808 using the determined channel information and the configured reservation signal 808 pattern. Once the reservation signal 808 is reconstructed, the first CV2X device may then filter the CV2X data signal 806 from the combination of CV2X data signal 806 and reservation signal 808 by subtracting the reconstructed reservation signal from the received data 806 and reservation signals 808, leaving a less noisy representation of the CV2X data signal 806. The CV2X data signal 806 can then be decoded or demodulated by the first CV2X device 802a.

In certain aspects, so that the reservation signal can be reconstructed, the reservation signal and the CV2X data signal may be generated according to certain formatting and structural parameters. For example, the reservation signal may be communicated in an OFDM format using the same numerology as the CV2X data signal, and may include DMRS symbols for the purpose of channel estimation. In certain aspects, a CV2X data signal is generated such that it does not interfere with the DMRSs of the reservation signal, meaning the CV2X data signal does not occupy time-frequency resources occupied by the DMRS symbols of the reservation signal. Two example approaches for reducing or eliminating interference with the reservation signal DMRS caused by CV2X data signaling are as follows, though other approaches may be used.

In one example approach, in certain aspects, the CV2X data signal may be modified to protect the DMRS of the reservation signal as discussed. That is, REs assigned for DMRS of the reservation signal may be left unoccupied by CV2X data signals. For example, because a CV2X device is configured with the reservation signal pattern, a CV2X data signal transmitted by the CV2X devices can be generated such that the CV2X data does not occupy the same REs that the DMRS of the reservation signal occupies. In one example, a CV2X device may introduce gap REs into the CV2X data signal, meaning the CV2X data signal does not occupy such gap REs, where the gap REs may be occupied by DMRS in the reservation signal. In a second approach, in certain aspects, the CV2X data signal may be modified such that the DMRS REs of the reservation signal match the DMRS REs of the CV2X data signal, meaning both the CV2X data signal and the reservation signal include DMRS, and the DMRS of each occupy the same REs.

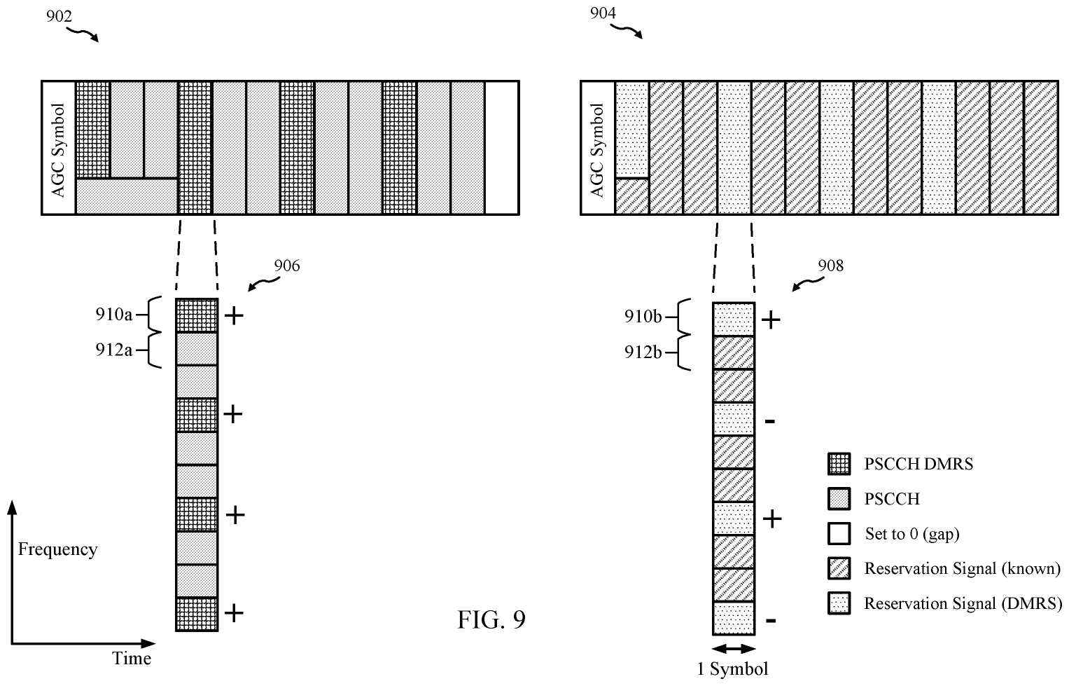

FIG. 9 is a block diagram conceptually illustrating an example of a CV2X data slot structure 902 and an example of a reservation signal slot structure 904 with an orthogonal cover code applied to a demodulation reference signal (DMRS) of each slot structure. For example, two different signals can be multiplied by the different orthogonal cover codes to allow a receiver to recover both of the different signals even though both signals were transmitted on overlapping frequency and time resources. An orthogonal cover code may include a length-2 Walsh code extended over a DMRS. In some examples, orthogonally coding DMRS transmissions may suppress inter-device interference, (e.g., between multiple CV2X devices in a side link communication), as well as increase reliability in separating a DMRS from one transmission from another DMRS of another transmission. It is appreciated that because there are many different slot structures, the disclosure is not limited to the example shown. Thus, any other suitable slot structure may also be used without departing from features disclosed herein. In certain aspects, as discussed, the CV2X data slot structure 902 and the reservation signal slot structure 904 are used for communication in the same slot, meaning they occupy the same time-frequency resources. For example, each of the symbols shown for each of the CV2X data slot structure 902 and the reservation signal slot structure 904 occupy the same time-frequency resources.

In this example, the CV2X data slot structure 902 and the reservation signal slot structure 904 are identical in terms of REs used for DMRS. One symbol 906/908, that is occupied by each of the CV2X data slot structure 902 and the reservation signal slot structure 904, is expanded to show which REs (e.g., DMRS REs 910a/912a, reservation signal REs 910b/912b) are used for DMRS, data, reservation signal, etc., for each of a CV2X data signal transmitted according to CV2X data slot structure 902 and a reservation signal transmitted according to the reservation signal slot structure 904. The legend provided in FIG. 9 indicates the content of each RE. Though symbol 906 and symbol 908 are referred to separately for ease of discussion, it should be noted that symbol 906 and symbol 908 refer to the same time-frequency resource, where symbol 906 refers to the occupation of the resource by the CV2X data signal and symbol 908 refers to the occupation of the resource by the reservation signal.

In the CV2X data slot structure 902, symbol 906 is expanded to show the type of data in each RE of the symbol 906. As shown, the symbol 906 includes a DMRS (e.g., on a PSCCH), and therefore may be referred to as a DMRS symbol 906. As shown, DMRS symbol 906 includes REs 910a carrying DMRS (e.g., on PSCCH), and REs 912a not including DMRS (e.g., on PSCCH), and instead may carry data. Similarly, the reservation signal slot structure 904, includes a symbol 908 including a DMRS, and referred to as DMRS symbol 908. The DMRS symbol 908 includes REs 910b carrying DMRS (e.g., on a reservation signal), and REs 912b not including DMRS and instead carrying the reservation signal. As shown, the REs including DMRS are in the same time-frequency locations in both the CV2X data slot structure 902 and the reservation signal slot structure 904.

The plus and minus signs in the symbols 906 and 908 are a visual indication that an orthogonal cover code (e.g., length-2 Walsh code) is applied to the DMRS signals, so that the DMRS signals of both the CV2X data signal and the reservation signal are recoverable at the receiver side. In particular, a different orthogonal cover code, shown by a different pattern of plus and minus signs, is applied to each of the CV2X data signal as shown in symbol 906 and the reservation signal as shown in symbol 908, such that they are encoded differently. A receiver of the CV2X data signal and the reservation signal, based on the different orthogonal cover codes applied to each, can then differentiate between the DMRS within each of the CV2X data signal and the reservation signal, even though the DMRS of each occupy the same time-frequency resources (REs).

### Example Techniques for Transmitting Reservation Signals over Dedicated Subchannels

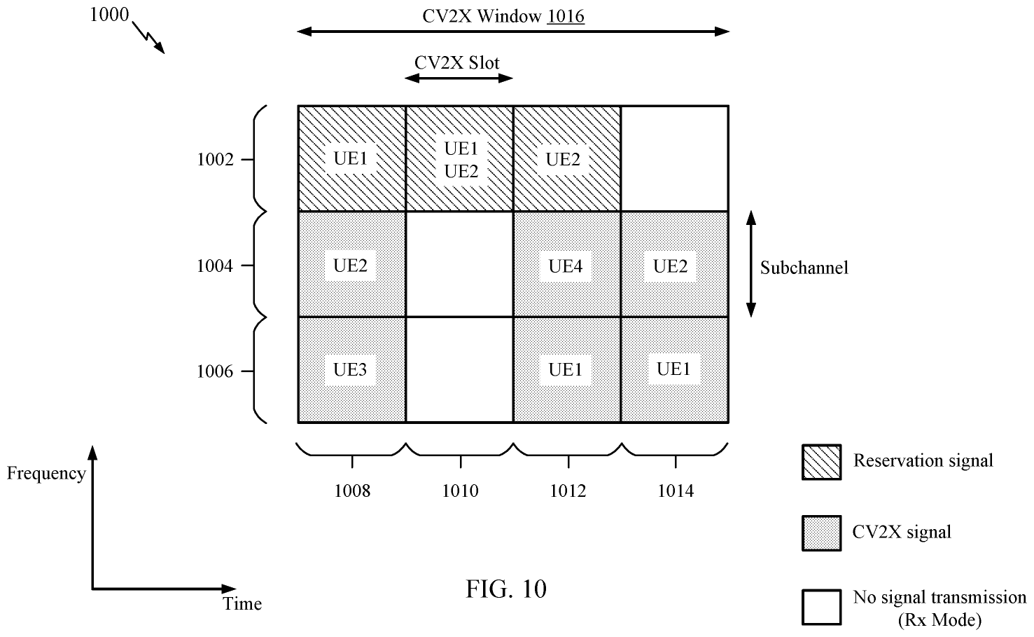

FIG. 10 is a block diagram conceptually illustrating three subchannels (e.g., a first subchannel 1002, a second subchannel 1004, and a third subchannel 1006) of a frequency band 1000 of an unlicensed spectrum within a CV2X window 1016. Though three subchannels are shown, it should be appreciated that frequency band 1000 may include any suitable number of subchannels. Further, the CV2X window 1016 is subdivided in time into four slots: a first slot 1008, a second slot 1010, a third slot 1012, and a fourth slot 1014. Though four slots are shown, it should be appreciated that the CV2X window 1016 may occupy any suitable number of time periods (e.g., slots).

In this example, four CV2X devices (e.g., UE 120 of FIGS. 1 and 2, UE 302 of FIG. 3, and/or CV2X devices 502 of FIG. 5) are shown communicating within the CV2X window 1016 via the three subchannels. CV2X devices include UE1, UE2, UE3, and UE4. Though four CV2X devices are shown, it should be appreciated that any suitable number of CV2X devices may be communicating in CV2X window 1016 on frequency band 1000. In certain aspects, four CV2X devices are shown so as to illustrate different possible scenarios for communication in different slots.

In certain aspects, one or more CV2X subchannels may be used for transmission of reservation signals and not for transmission of data signals by CV2X devices (e.g., in a deployment). Such one or more CV2X subchannels may be referred to as reservation signal dedicated subchannels. It should be noted that such reservation signal dedicated subchannels may not be dedicated for transmission by a single CV2X device, but rather may be dedicated for transmission by however many reservation CV2X devices there are transmitting reservation signals. In this example, the first subchannel 1002 is a reservation signal dedicated subchannel for transmission of reservation signals. As an example, UE1 and UE2 are shown as reservation devices for CV2X window 1016 (e.g., UE1 and UE2 can only transmit data and/or reservation signals during CV2X window 1016), while UE3 and UE4 are not reservation devices (e.g., UE3 and UE4 can transmit and can also receive data during the CV2X window 1016). As such, if either of the reservation devices UE1 and UE2 are not transmitting data within a particular slot, they are transmitting a reservation signal within that particular slot. In the example shown, UE2 transmits data over the first slot 1008 in the second subchannel 1004, and UE1 transmits a reservation signal over the first slot 1008 in the first subchannel 1002 (e.g., the reservation signal dedicated subchannel) because UE1 does not have data to transmit in the first slot 1008. In the second slot 1010, both UE1 and UE2 transmit a reservation signal in the first subchannel 1002 because neither have data to transmit. In the third slot 1012, UE1 has data to transmit in the third subchannel, and therefore does not transmit a reservation signal. UE2 transmits a reservation signal during the third slot 1012 because it has no data to transmit. Finally, in the fourth slot 1014, no reservation signal is transmitted because both UE1 and UE2 are transmitting data in the third subchannel 1006 and the second subchannel 1004, respectively.

Here, of the plurality of CV2X devices, UE1 and UE2 are reservation devices. That is, UE1 and UE2 can each transmit one of a reservation signal or data signal within a time period (e.g., a slot or a CV2X window) in the frequency band 1000. The reservation signal and/or the data signal may cause any other wireless devices (e.g., non-CV2X devices) to determine that the frequency band 1000 is busy during the first time period. For example, transmission of CV2X data signals and/or reservation signals over the frequency band 1000 may cause non-CV2X devices performing LBT to measure energy above a threshold, and thus determine the frequency band 1000 is busy, and therefore refrain from communicating. Accordingly, the plurality of CV2X devices may wirelessly communicate over the frequency band 1000 during the first time period. During a non-CV2X window, the CV2X devices may refrain from transmitting signals. In this case, the non-CV2X window is a region of time for allowing the non-CV2X devices to communicate data. In some examples, the frequency band 1000 is an unlicensed spectrum used by the CV2X devices for sidelink communications with other CV2X devices. In some examples, the sidelink is used for vehicle-to-everything (V2X) communication, including CV2X communication. In some examples, the CV2X time window is one of a plurality of CV2X time periods that occur periodically over the frequency band.

### Example Techniques for Dynamic Selection of Slot for Transmitting Reservation Signals

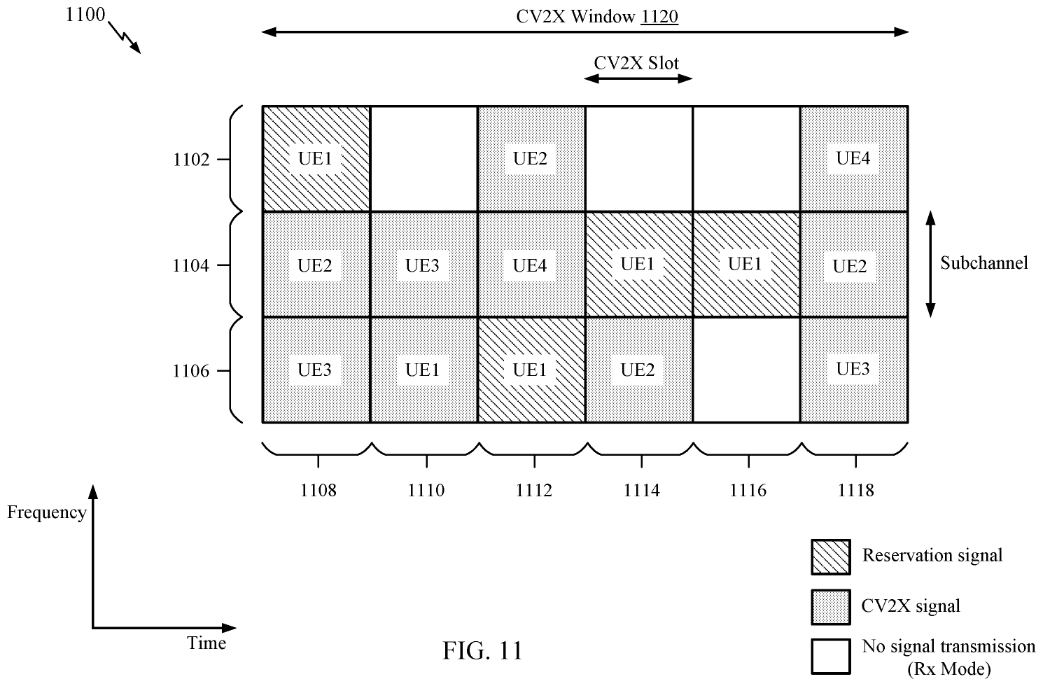

FIG. 11 is a block diagram conceptually illustrating three subchannels (e.g., a first subchannel 1102, a second subchannel 1104, and a third subchannel 1106) of a frequency band 1100 of an unlicensed spectrum within a CV2X window 1120. Though three subchannels are shown, it should be appreciated that frequency band 1100 may include any suitable number of subchannels. Further, the CV2X window 1120 is subdivided in time into six slots: a first slot 1108, a second slot 1110, a third slot 1112, a fourth slot 1114, a fifth slot 1116, and a sixth slot 1118. Though six slots are shown, it should be appreciated that the CV2X window 1120 may occupy any suitable number of time periods (e.g., slots).

In this example, four CV2X devices (e.g., UE 120 of FIGS. 1 and 2, UE 302 of FIG. 3, and/or CV2X devices 502 of FIG. 5) are shown communicating within the CV2X window 1120 on frequency band 1100. The CV2X devices include UE1, UE2, UE3, and UE4. Though four CV2X devices are shown, it should be appreciated that any suitable number of CV2X devices may be communicating in CV2X window 1120 on frequency band 1100. In certain aspects, four CV2X devices are shown so as to illustrate different possible scenarios for communication in different slots.

In this example, no subchannel 1102-1106 of frequency band 1100 is dedicated to transmission of reservation signals. Instead, a reservation device (e.g., UE1) (e.g., dynamically) selects a subchannel of subchannels 1102-1106 for transmission of the reservation signal, such as in the same manner used for transmission of CV2X data. In certain aspects, the reservation device UE1 may select a subchannel of subchannels 1102-1106 for communicating a reservation signal at random. In certain aspects, the reservation device UE1 may select a subchannel of subchannels 1102-1106 for communicating a reservation signal based on known scheduling (e.g., based on received sidelink control information from one or more other CV2X devices or a BS indicating what subchannels will have data communicated over them) communicated between the CV2X devices over the unlicensed spectrum or a licensed spectrum.

In the example shown, UE1 transmits a reservation signal over the first subchannel 1102 during the first slot 1108, while UE2 and UE3 transmit data signals over the second subchannel 1104 and the third subchannel 1106. In the second slot 1110, UE1 does not transmit a reservation signal because it has data to transmit. As discussed, a reservation device may transmit data to reserve frequency band 1100 when it has data to transmit instead of transmitting a reservation signal. In the third slot 1112, UE1 selects the third subchannel 1106 to transmit a reservation signal, such as because UE2 and UE4 are scheduled to transmit data over the first subchannel 1102 and the second subchannel 1104, respectively. In the fourth slot 1114 and the fifth slot 1116, UE1 transmits a reservation signal over the second subchannel. And finally, in the sixth slot 1118, UE1 may either: (i) forego transmission of either data or reservation signal due to transmission of data by UE4, UE2, and UE3 (e.g., UE1 may know future traffic of the other UEs from sidelink control information (SCI) decoding), or (ii) transmit a reservation signal on top of (e.g., using the same slot and subchannel as) one of the other CV2X devices.

As discussed, in some cases, a reservation device UE1 may determine that there is no unoccupied subchannel over which it can transmit data or a reservation signal in a slot within the CV2X window 1120. As shown in the example of FIG. 11, three CV2X devices UE2-UE4 already have reserved (are scheduled to transmit over) each of subchannels 1102-1106 of frequency band 1100 during the sixth slot 1118. In this case, the reservation device UE1 may determine which of the CV2X devices UE2-UE4 that are scheduled to transmit during the sixth slot 1118 are transmitting with the lowest amount of power (e.g., reference signal receive power (RSRP), received signal strength indicator (RSSI), and/or reference signal received quality (RSRQ)). In one example, the determination is based on which CV2X device UE2-UE4 is farthest away from the reservation device UE1 (e.g., the reservation device UE1 senses a weaker signal from one of the CV2X devices UE2-UE4 due to the distance between UE1 and the one of the CV2X devices UE2-UE4). The reservation device UE1 may then determine to transmit the reservation signal or data signal over the subchannel reserved by the CV2X device UE2-UE4 with the weakest signal. Accordingly, a CV2X device that receives both the transmission from UE1 and the one of CV2X device UE2-UE4 may receive the signals with different signal strength, thereby making it easier to decode the signal received with higher signal strength among the two, thereby reducing the impact of the colliding use of the time-frequency resource corresponding to the slot-subchannel.

It should be noted that if a reservation device UE1 knows that there will be transmission by another CV2X device UE2-UE4 in a given slot, the reservation device UE1 may not need to transmit a reservation signal (e.g., if it has no data to transmit) because the transmission by the other (e.g., possibly non-reservation) CV2X device UE2-UE4 will effectively serve as signal energy that prevents non-CV2X devices from using the frequency band 1100 (e.g., the transmission by the other CV2X device will render the frequency band 1100 busy from the perspective of non-CV2X devices). In certain aspects, a gap symbol is included in a signal transmitted by the other CV2X device UE2-UE4. The gap symbol may be a time period that could be used by non-CV2X devices to sense the frequency band as idle and transmit non-CV2X data during the CV2X window. Accordingly, in certain aspects, a reservation device UE1 may always transmit a reservation signal and/or a data signal in any given slot to avoid non-CV2X devices detecting the frequency band as idle.

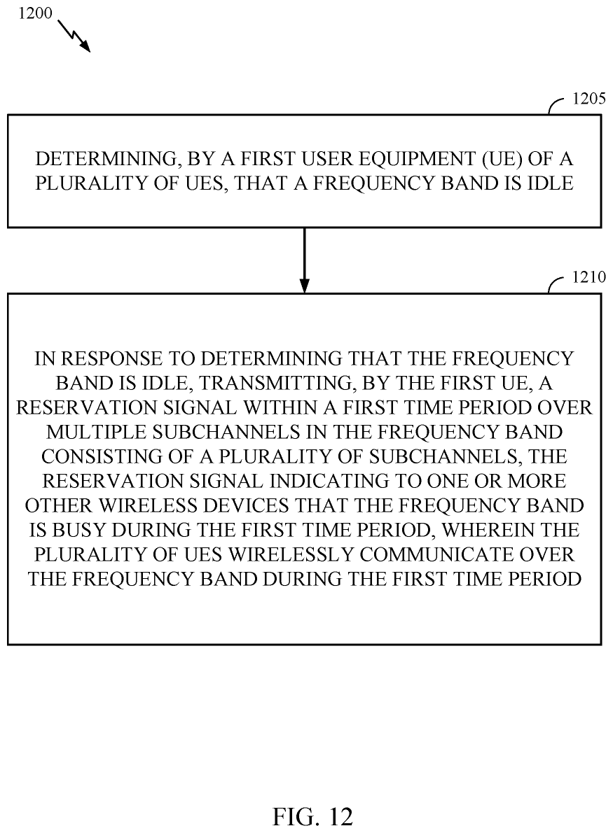

FIG. 12 is a flow diagram illustrating example operations 1200 for wireless communication, in accordance with certain aspects of the present disclosure. The operations 1200 may be performed, for example, by a UE (e.g., such as the UE 120a in the wireless communication network 100 of FIG. 1).

Operations 1200 may be implemented as software components that are executed and run on one or more processors (e.g., controller/processor 240/280 of FIG. 2). Further, the transmission and reception of signals in operations 1200 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1200 may begin, at block 1205, by determining, by a first user equipment (UE) of a plurality of UEs, that a frequency band is idle.

The operations may proceed to block 1210 by, in response to determining that the frequency band is idle, transmitting, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

In certain aspects, the operations 1200 further comprise transmitting, by the first UE, data over a first subchannel of the plurality of subchannels other than the multiple subchannels, the data transmitted within the first time period.

In certain aspects, the operations 1200 further comprise refraining, by the first UE, from transmitting in a second time period, wherein the one or more other wireless devices wirelessly communicate over the frequency band during the second time period.

In certain aspects, the first time period comprises a first slot of a plurality of slots of a first time window.

In certain aspects, the operations 1200 further comprise, for each of the plurality of slots other than the first slot, transmitting, by the first UE, a corresponding reservation signal within a corresponding slot over corresponding multiple subchannels of the plurality of subchannels, the corresponding reservation signal indicating to the one or more other wireless devices that the frequency band is busy during the corresponding slot, wherein the plurality of UEs wirelessly communicate over the frequency band during the corresponding slot.

In certain aspects, the reservation signal is transmitted over a first subset of frequency resources of the multiple subchannels, the operations 1200 further comprising: transmitting, by the first UE, a second reservation signal within a second slot of the plurality of slots, the second reservation signal transmitted over a second subset of frequency resources of the corresponding multiple subchannels, the first subset of frequency resources corresponding to a different set of frequencies than the second subset of frequency resources.

In certain aspects, the reservation signal is transmitted over a first subset of frequency resources of the multiple subchannels, the operations 1200 further comprising: transmitting, by the first UE, a second reservation signal within a second slot of the plurality of slots, the second reservation signal transmitted over the first subset of frequency resources of the corresponding multiple subchannels.

In certain aspects, each of the corresponding multiple subchannels corresponds to a different set of subchannels.

In certain aspects, the multiple subchannels comprise the plurality of subchannels.

In certain aspects, the reservation signal is transmitted over a first subset of frequency resources of the multiple subchannels during the first time period.

In certain aspects, wherein the first subset of frequency resources consists of one resource element in each subchannel of the multiple subchannels.

In certain aspects, the operations 1200 further comprise transmitting by the first UE, a demodulation reference signal (DMRS) over a second subset of frequency resources of the plurality of subchannels during the first time period, the second subset of frequency resources being separate from the first subset of frequency resources.

In certain aspects, the second subset of frequency resources during the first time period are reserved for transmission of DMRS by one or more reservation UEs of the plurality of UEs including the first UE.

In certain aspects, the operations 1200 further comprise applying an orthogonal cover code to the DMRS, the orthogonal cover code being use for transmission of DMRS by one or more reservation UEs of the plurality of UEs including the first UE.

In certain aspects, each of the plurality of UEs are preconfigured with a content of the reservation signal prior to transmission of the reservation signal by the first UE.

In certain aspects, the reservation signal comprises a demodulation reference signal (DMRS).

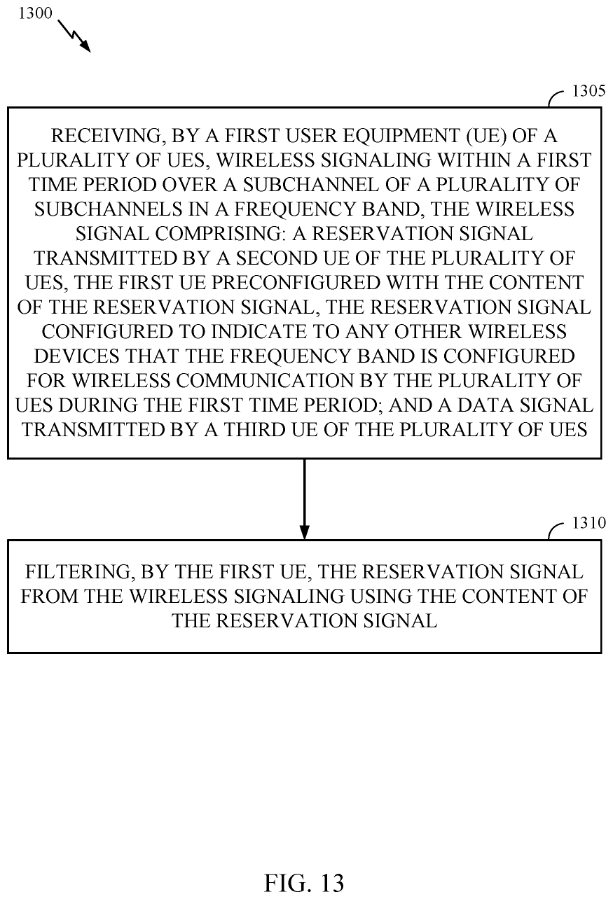

FIG. 13 is a flow diagram illustrating example operations 1300 for wireless communication, in accordance with certain aspects of the present disclosure. The operations 1300 may be performed, for example, by a UE (e.g., such as the UE 120a in the wireless communication network 100 of FIG. 1).

Operations 1300 may be implemented as software components that are executed and run on one or more processors (e.g., controller/processor 240/280 of FIG. 2). Further, the transmission and reception of signals in operations 1300 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1300 may begin, at block 1305, by receiving, by a first user equipment (UE) of a plurality of UEs, wireless signaling within a first time period over a subchannel of a plurality of subchannels in a frequency band, the wireless signal comprising: a reservation signal from a second UE of the plurality of UEs, the first UE preconfigured with a content of the reservation signal, the reservation signal indicating to one or more other wireless devices that the frequency band is busy during the first time period, wherein the plurality of UEs wirelessly communicate over the frequency band during the first time period; and a data signal from a third UE of the plurality of UEs.

The operations 1300 may proceed to block 1310, by filtering, by the first UE, the reservation signal from the wireless signaling using the content of the reservation signal.

In certain aspects, the reservation signal is received by the first UE over a set of wireless resources, and wherein the set of wireless resources comprises: (i) a first subset of resources over which the content of the reservation signal is received, and (ii) a second subset of resources over which a demodulation reference signal (DMRS) is received.

In certain aspects, the data signal is received from the third UE over the set of wireless resources other than the second subset of resources.

In certain aspects, the data signal is received from the third UE over the set of wireless resources, the data signal comprises a second DMRS received over the second subset of resources, the DMRS has a first orthogonal cover code applied, and the second DMRS has a second orthogonal cover code applied.

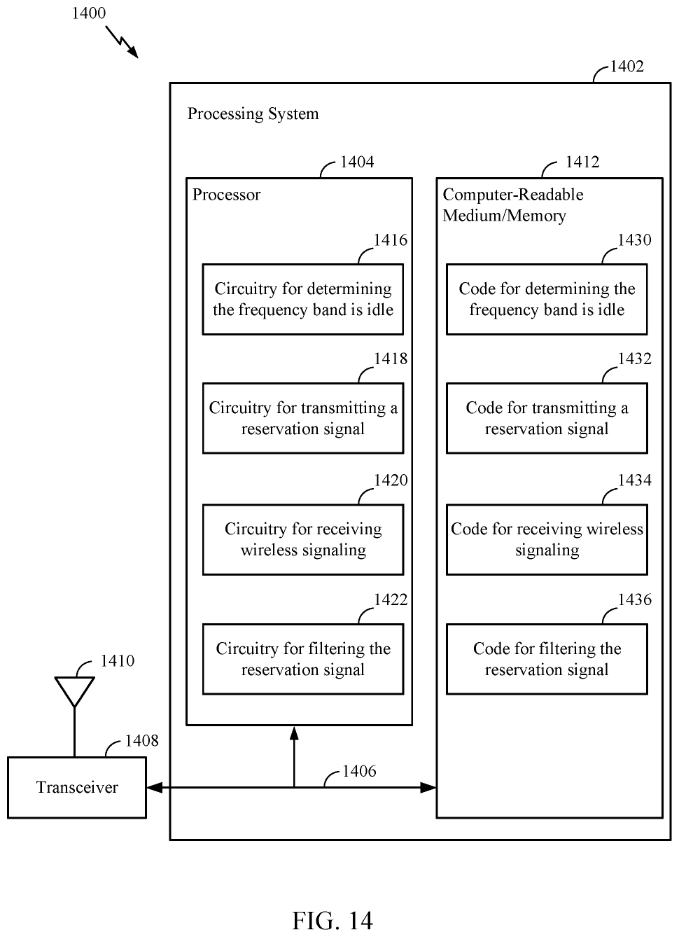

FIG. 14 illustrates a communications device 1400 that may include various components (e.g., corresponding to means-plus-function components) configured to perform operations for the techniques disclosed herein, such as the operations illustrated in FIGS. 12 and 13. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIGS. 12 and 13, or other operations for performing the various techniques discussed herein for performing sidelink communications in unlicensed bands.

In certain aspects, computer-readable medium/memory 1412 stores code 1430 for determining that a frequency band is idle. In certain aspects, computer-readable medium/memory 1412 stores code 1432 for, in response to determining that the frequency band is idle, transmitting, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

The computer-readable medium/memory 1412 also stores code 1434 for receiving, by a first user equipment (UE) of a plurality of UEs, wireless signaling within a first time period over a subchannel of a plurality of subchannels in a frequency band, the wireless signal comprising: a reservation signal transmitted by a second UE of the plurality of UEs, the first UE preconfigured with the content of the reservation signal, the reservation signal configured to indicate to one or more other wireless devices that the frequency band is configured for wireless communication by the plurality of UEs during the first time period; and a data signal transmitted by a third UE of the plurality of UEs.

In certain aspects, computer-readable medium/memory 1412 stores code 1436 for filtering, by the first UE, the reservation signal from the wireless signaling using the content of the reservation signal.

In certain aspects, the processor 1404 has circuitry configured to implement the code stored in the computer-readable medium/memory 1412. The processor 1404 includes circuitry 1416 for determining that a frequency band is idle. The processor 1404 also includes circuitry 1418 for, in response to determining that the frequency band is idle, transmitting, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

In certain aspects, the processor 1404 has circuitry configured to implement the code stored in the computer-readable medium/memory 1412. The processor 1404 includes circuitry 1420 for receiving, by a first user equipment (UE) of a plurality of UEs, wireless signaling within a first time period over a subchannel of a plurality of subchannels in a frequency band, the wireless signal comprising: a reservation signal transmitted by a second UE of the plurality of UEs, the first UE preconfigured with the content of the reservation signal, the reservation signal configured to indicate to one or more other wireless devices that the frequency band is configured for wireless communication by the plurality of UEs during the first time period; and a data signal transmitted by a third UE of the plurality of UEs.

In certain aspects, the processor 1404 has circuitry configured to implement the code stored in the computer-readable medium/memory 1412. The processor 1404 includes circuitry 1422 for filtering, by the first UE, the reservation signal from the wireless signaling using the content of the reservation signal.

For example, means for transmitting (or means for outputting for transmission) may include a transmitter and/or an antenna(s) 234 or the BS 110a or transceiver 254 and/or antenna(s) 252 of the UE 120a illustrated in FIG. 2, circuitry 1418 for, in response to sensing that the unlicensed frequency band is idle, transmitting at least one of a data signal or a reservation signal during an entire duration of a time period over one or more subchannels of the plurality of subchannels, wherein the at least one of the data signal or the reservation signal is configured to reserve the unlicensed frequency band during the time period, wherein the transmission of the at least one of the data signal or the reservation signal during the entire time period comprises transmission of the reservation signal for at least a portion of the time period over less than all of the plurality of subchannels, of the communication device 1400 in FIG. 14.

Means for receiving (or means for obtaining or means for measuring) may include a receiver and/or an antenna(s) 234 of the BS 110a or a receiver and/or antenna(s) 252 of the UE 120a illustrated in FIG. 2 and/or circuitry 1420 for receiving, by a first user equipment (UE) of a plurality of UEs, wireless signaling within a first time period over a subchannel of a plurality of subchannels in a frequency band, the wireless signal comprising: a reservation signal transmitted by a second UE of the plurality of UEs, the first UE preconfigured with the content of the reservation signal, the reservation signal configured to indicate to any other wireless devices that the frequency band is configured for wireless communication by the plurality of UEs during the first time period; and a data signal transmitted by a third UE of the plurality of UEs, of the communication device 1400 in FIG. 14.

Means for communicating may include a transmitter, a receiver or both. Means for generating, means for performing, means for filtering, means for taking action, means for determining, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1402 of the communication device 1400 in FIG. 14.

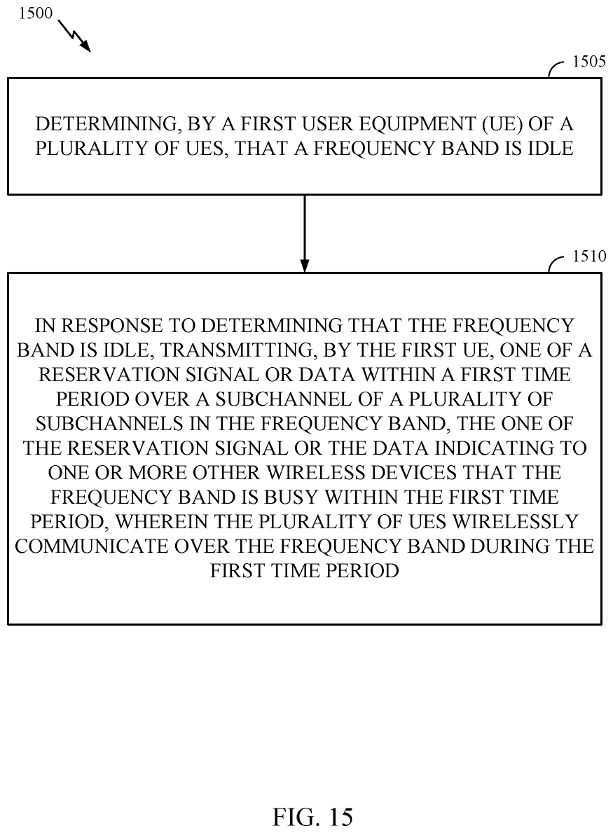

FIG. 15 is a flow diagram illustrating example operations 1500 for wireless communication, in accordance with certain aspects of the present disclosure. The operations 1500 may be performed, for example, by a UE (e.g., such as the UE 120a in the wireless communication network 100 of FIG. 1).

Operations 1500 may be implemented as software components that are executed and run on one or more processors (e.g., controller/processor 240/280 of FIG. 2). Further, the transmission and reception of signals in operations 1500 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1500 may begin, at block 1505, by determining, by a first user equipment (UE) of a plurality of UEs, that a frequency band is idle.

The operations 1500 may then proceed to block 1510 by, in response to determining that the frequency band is idle, transmitting, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

In certain aspects, the operations 1500 further comprise refraining, by the first UE, from transmitting in a second time period, wherein the one or more other wireless devices wirelessly communicate over the frequency band within the second time period.

In certain aspects, the first time period comprises a slot of a plurality of slots of a first time window, the operations 1500 further comprising: for each of the plurality of slots other than the slot, transmitting, by the first UE, one of a corresponding reservation signal or corresponding data within a corresponding slot over at least one subchannel of the plurality of subchannels, the one of the corresponding reservation signal or the corresponding data indicating to the one or more other wireless devices that the frequency band is busy within the first time period, wherein the plurality of UEs wirelessly communicate over the frequency band within the corresponding slot.

In certain aspects, one of the plurality of subchannels is reserved for transmission of only reservation signals by one or more reservation UEs including the first UE.

In certain aspects, transmitting the one of the reservation signal or the data comprises: determining whether the first UE has data to transmit; and if the first UE has data to transmit, transmitting the data within the first time period; otherwise, transmitting the reservation signal within the first time period.

In certain aspects, operations 1500 further comprise dynamically selecting the subchannel from the plurality of subchannels.

In certain aspects, the frequency band comprises a sidelink in an unlicensed spectrum.

In certain aspects, when each of the plurality of subchannels is reserved by any of the plurality of UEs other than the first UE, the subchannel has a lowest measured power among the plurality of subchannels, and when at least one of the plurality of subchannels is unreserved by the plurality of UEs other than the first UE, the subchannel is one of the at least one of the plurality of subchannels.

In certain aspects, the frequency band comprises a sidelink in an unlicensed spectrum.

In certain aspects, the sidelink is used for vehicle to everything communication.

In certain aspects, the first time period is one of a plurality of time periods of a first time window that occurs periodically.

In certain aspects, the first time period is one of a plurality of time periods of a first time window that occurs periodically.

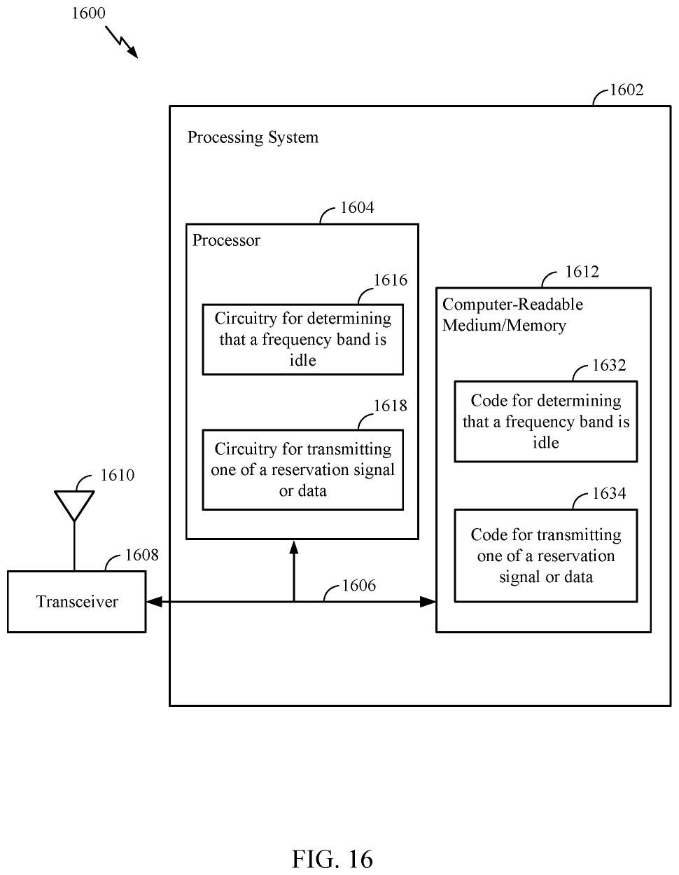

FIG. 16 illustrates a communications device 1600 that may include various components (e.g., corresponding to means-plus-function components) configured to perform operations for the techniques disclosed herein, such as the operations illustrated in FIG. 15. The communications device 1600 includes a processing system 1602 coupled to a transceiver 1608 (e.g., a transmitter and/or a receiver). The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes a processor 1604 coupled to a computer-readable medium/memory 1612 via a bus 1606. In certain aspects, the computer-readable medium/memory 1612 is configured to store instructions (e.g., computer-executable code) that when executed by the processor 1604, cause the processor 1604 to perform the operations illustrated in FIG. 15, or other operations for performing the various techniques discussed herein for performing sidelink communications in unlicensed bands.

In certain aspects, computer-readable medium/memory 1612 stores code 1632 for determining that a frequency band is idle.

In certain aspects, computer-readable medium/memory 1612 stores code 1634 for, in response to determining that the frequency band is idle, transmitting, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

In certain aspects, the processor 1604 has circuitry configured to implement the code stored in the computer-readable medium/memory 1612. The processor 1604 includes circuitry 1616 for determining that a frequency band is idle.

The processor 1604 includes circuitry 1618 for, in response to determining that the frequency band is idle, transmitting, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

For example, means for transmitting (or means for outputting for transmission) may include a transmitter and/or an antenna(s) 234 or the BS 110a or the transceiver 254 and/or antenna(s) 252 of the UE 120a illustrated in FIG. 2, circuitry 1618 for, in response to determining that the frequency band is idle, transmitting, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period, of the communication device 1600 in FIG. 16.

Means for communicating may include a transmitter, a receiver or both. Means for generating, means for performing, means for filtering, means for taking action, means for determining that a frequency band is idle, means for coordinating, and means for measuring may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1602 of the communication device 1600 in FIG. 16.

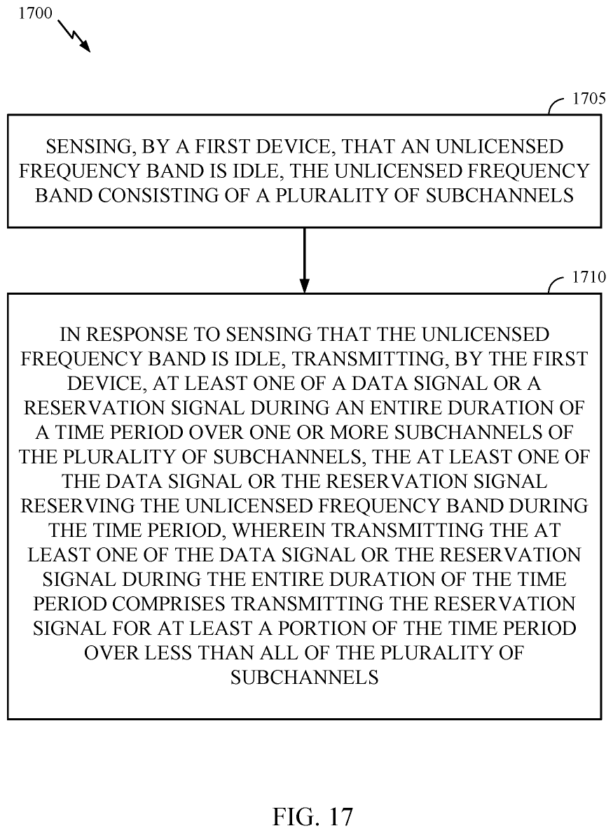

FIG. 17 is a flow diagram illustrating example operations 1700 for wireless communication, in accordance with certain aspects of the present disclosure. The operations 1700 may be performed, for example, by a UE (e.g., such as the UE 120a in the wireless communication network 100 of FIG. 1).

Operations 1700 may be implemented as software components that are executed and run on one or more processors (e.g., controller/processor 240/280 of FIG. 2). Further, the transmission and reception of signals in operations 1700 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1700 may begin, at block 1705, by sensing, by a first device, that an unlicensed frequency band is idle, the unlicensed frequency band consisting of a plurality of sub channels.

The operations 1700 may then proceed to block 1710 by, in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels.

In certain aspects, the time period comprises a first slot of a plurality of slots of a time window.

In certain aspects, operations 1700 include, for each of the plurality of slots other than the first slot, transmitting, by the first device, at least one of a corresponding data signal or a corresponding reservation signal during the entire duration of the slot over one or more corresponding subchannels of the plurality of subchannels.

In certain aspects, the reservation signal is transmitted over a first subset of frequency resources of the less than all of the plurality of subchannels for the at least the portion of the time period, and further comprising: transmitting, by the first device, a second reservation signal within a second slot of the plurality of slots, the second reservation signal transmitted over a second subset of frequency resources of the less than all of the plurality of subchannels, the first subset of frequency resources corresponding to a different set of frequencies than the second subset of frequency resources.

In certain aspects, the reservation signal is transmitted over a subset of frequency resources of the less than all of the plurality of subchannels for the at least the portion of the time period, and further comprising: transmitting, by the first device, a second reservation signal within a second slot of the plurality of slots, the second reservation signal transmitted over the subset of frequency resources of the less than all of the plurality of subchannels.

In certain aspects, the reservation signal is transmitted over a first subset of frequency resources of the less than all of the plurality of subchannels during the at least the portion of the time period, and wherein the first subset of frequency resources consists of at least one resource element (RE) in each subchannel of the less than all of the plurality of subchannels.

In certain aspects, the operations 1700 further include transmitting by the first device, a demodulation reference signal (DMRS) over a second subset of frequency resources of the less than all of the plurality of subchannels during the at least the portion of the time period, the second subset of frequency resources being separate from the first subset of frequency resources.

In certain aspects, the operations 1700 further include applying an orthogonal cover code to the DMRS.

In certain aspects, the operations 1700 further include storing, by the first device, an indication of a characteristic of the reservation signal prior to transmission of the reservation signal.

In certain aspects, the at least one of the data signal or the reservation signal indicates to one or more other wireless devices that the frequency band is busy during the time period, wherein a plurality of devices wirelessly communicate over the frequency band during the time period.

In certain aspects, the reservation signal comprises a demodulation reference signal (DMRS).

In certain aspects, the operations 1700 further include dynamically selecting the one or more subchannels from the plurality of subchannels prior to transmitting the at least one of the data signal or the reservation signal.

In certain aspects, one of the plurality of subchannels is reserved for transmission of only reservation signals.

In certain aspects, transmitting the at least one of the data signal or the reservation signal comprises: transmitting the reservation signal when the UE does not have data to transmit during the time period; and transmitting the data signal when the UE has data to transmit during the time period.

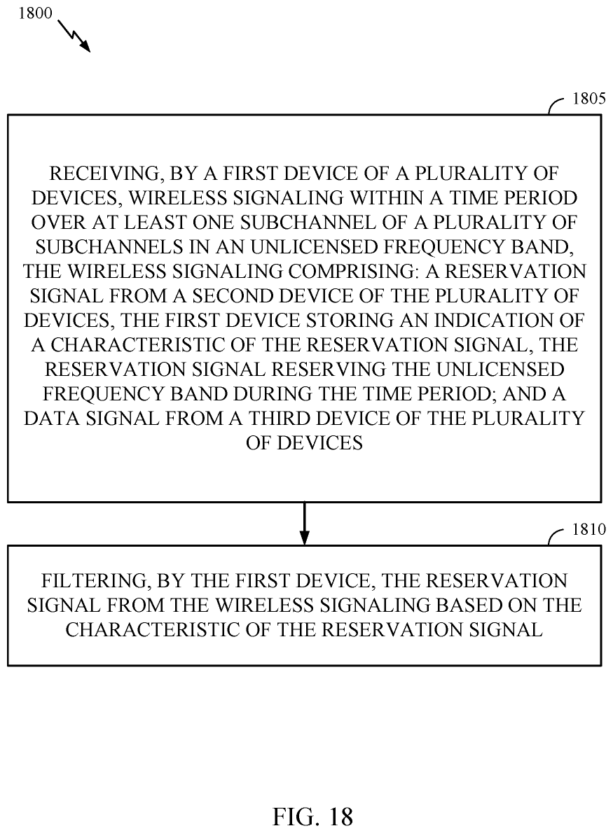

FIG. 18 is a flow diagram illustrating example operations 1800 for wireless communication, in accordance with certain aspects of the present disclosure. The operations 1800 may be performed, for example, by a UE (e.g., such as the UE 120a in the wireless communication network 100 of FIG. 1).

Operations 1800 may be implemented as software components that are executed and run on one or more processors (e.g., controller/processor 240/280 of FIG. 2). Further, the transmission and reception of signals in operations 1800 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 1800 may begin, at block 1805, by receiving, by a first device of a plurality of devices, wireless signaling within a time period over at least one subchannel of a plurality of subchannels in an unlicensed frequency band, the wireless signaling comprising: a reservation signal from a second device of the plurality of devices, the first device storing an indication of a characteristic of the reservation signal, the reservation signal reserving the unlicensed frequency band during the time period; and a data signal from a third device of the plurality of devices.

The operations 1800 may then proceed to block 1810 by, filtering, by the first device, the reservation signal from the wireless signaling based on the characteristic of the reservation signal.

In certain aspects, the reservation signal is received by the first device over a set of wireless resources, and wherein the set of wireless resources comprises: (i) a first subset of resources over which the reservation signal is received, and (ii) a second subset of resources over which a demodulation reference signal (DMRS) is received.

In certain aspects, the data signal is received from the third device over the set of wireless resources other than the second subset of resources.

In certain aspects, the data signal is received from the third device over the set of wireless resources, the data signal comprises a second DMRS received over the second subset of resources, the DMRS has a first orthogonal cover code applied, and the second DMRS has a second orthogonal cover code applied.

In certain aspects, the characteristic of the reservation signal comprises one or more of: the at least one subchannel over which the reservation signal is transmitted; a portion of the at least one subchannel over which the reservation signal is transmitted; a resource element (RE) occupied by the reservation signal, and one or more symbols within the RE; a waveform of the reservation signal; or a time and frequency pattern occupied by the reservation signal; and wherein the indication comprises one or more of an index or a mapping corresponding to the characteristic of the reservation signal.

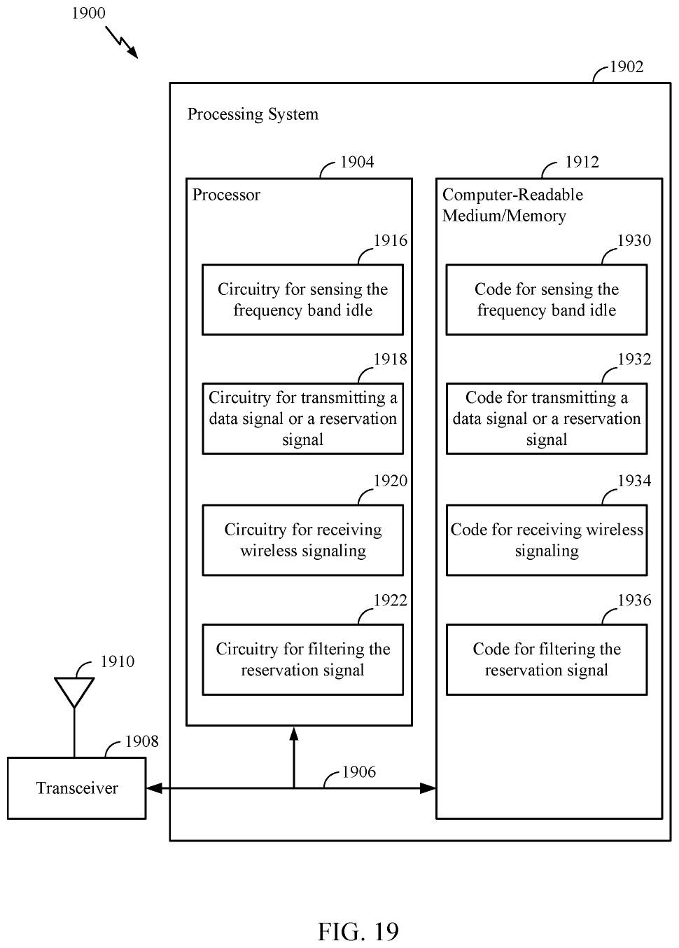

FIG. 19 illustrates a communications device 1900 that may include various components (e.g., corresponding to means-plus-function components) configured to perform operations for the techniques disclosed herein, such as the operations illustrated in FIGS. 17 and 18. The communications device 1900 includes a processing system 1902 coupled to a transceiver 1908 (e.g., a transmitter and/or a receiver). The transceiver 1908 is configured to transmit and receive signals for the communications device 1900 via an antenna 1910, such as the various signals as described herein. The processing system 1902 may be configured to perform processing functions for the communications device 1900, including processing signals received and/or to be transmitted by the communications device 1900.

The processing system 1902 includes a processor 1904 coupled to a computer-readable medium/memory 1912 via a bus 1906. In certain aspects, the computer-readable medium/memory 1912 is configured to store instructions (e.g., computer-executable code) that when executed by the processor 1904, cause the processor 1904 to perform the operations illustrated in FIGS. 17 and 18, or other operations for performing the various techniques discussed herein for performing sidelink communications in unlicensed bands.

In certain aspects, computer-readable medium/memory 1912 stores code 1930 for sensing, by a first device, that an unlicensed frequency band is idle, the unlicensed frequency band consisting of a plurality of subchannels.

In certain aspects, computer-readable medium/memory 1912 stores code 1932 for, in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels.

In certain aspects, computer-readable medium/memory 1912 stores code 1934 for, receiving, by a first device of a plurality of devices, wireless signaling within a time period over at least one subchannel of a plurality of subchannels in an unlicensed frequency band, the wireless signaling comprising: a reservation signal from a second device of the plurality of devices, the first device storing an indication of a characteristic of the reservation signal, the reservation signal reserving the unlicensed frequency band during the time period; and a data signal from a third device of the plurality of devices.

In certain aspects, computer-readable medium/memory 1912 stores code 1936 for filtering, by the first device, the reservation signal from the wireless signaling based on the characteristic of the reservation signal.

In certain aspects, the processor 1904 has circuitry configured to implement the code stored in the computer-readable medium/memory 1912. The processor 1904 includes circuitry 1916 for sensing, by a first device, that an unlicensed frequency band is idle, the unlicensed frequency band consisting of a plurality of subchannels.

The processor 1904 includes circuitry 1918 for, in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels.

The processor 1904 includes circuitry 1920 for receiving, by a first device of a plurality of devices, wireless signaling within a time period over at least one subchannel of a plurality of subchannels in an unlicensed frequency band, the wireless signaling comprising: a reservation signal from a second device of the plurality of devices, the first device storing an indication of a characteristic of the reservation signal, the reservation signal reserving the unlicensed frequency band during the time period; and a data signal from a third device of the plurality of devices.

The processor 1904 includes circuitry 1922 for filtering, by the first device, the reservation signal from the wireless signaling based on the characteristic of the reservation signal.

For example, means for transmitting (or means for outputting for transmission) may include a transmitter and/or an antenna(s) 234 or the BS 110a or the transceiver 254 and/or antenna(s) 252 of the UE 120a illustrated in FIG. 2, circuitry 1918 for, in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels, of the communication device 1900 in FIG. 19.

Means for receiving (or means for obtaining or means for measuring) may include a receiver and/or an antenna(s) 234 of the BS 110a or a receiver and/or antenna(s) 252 of the UE 120a illustrated in FIG. 2 and/or circuitry 1920 for receiving, by a first device of a plurality of devices, wireless signaling within a time period over at least one subchannel of a plurality of subchannels in an unlicensed frequency band, the wireless signaling comprising: a reservation signal from a second device of the plurality of devices, the first device storing an indication of a characteristic of the reservation signal, the reservation signal reserving the unlicensed frequency band during the time period; and a data signal from a third device of the plurality of devices, of the communication device 1900 in FIG. 19.

Means for communicating may include a transmitter, a receiver or both. Means for generating, means for performing, means for filtering a reservation signal from the wireless signaling based on the characteristic of the reservation signal, means for taking action, means for determining, means for coordinating, means for measuring, and means for sensing that an unlicensed frequency band is idle, the unlicensed frequency band consisting of a plurality of subchannels may include a processing system, which may include one or more processors, such as the transmit processor 220, the TX MIMO processor 230, the receive processor 238, and/or the controller/processor 240 of the BS 110a or the receive processor 258, the transmit processor 264, the TX MIMO processor 266, and/or the controller/processor 280 of the UE 120a illustrated in FIG. 2 and/or the processing system 1902 of the communication device 1900 in FIG. 19.

### Example Aspects

Aspect 1: A first device, comprising: a memory; and a processor coupled to the memory, the processor and the memory configured to: sense that an unlicensed frequency band is idle, the unlicensed frequency band consisting of a plurality of subchannels; and in response to sensing that the unlicensed frequency band is idle, transmit at least one of a data signal or a reservation signal during an entire duration of a time period over one or more subchannels of the plurality of subchannels, at least one of the data signal or the reservation signal reserving the unlicensed frequency band during the time period, wherein the transmission of the at least one of the data signal or the reservation signal during the time period comprises transmission of the reservation signal for at least a portion of the time period over less than all of the plurality of subchannels.

Aspect 2: The first device of Aspect 1, wherein the time period comprises a first slot of a plurality of slots of a time window.

Aspect 3: The first device of any of Aspects 1 and 2, further comprising a transceiver, wherein the processor, the memory, and the transceiver are further configured to transmit, for each of the plurality of slots other than the first slot, at least one of a corresponding data signal or a corresponding reservation signal during the entire duration of the slot over one or more corresponding subchannels of the plurality of subchannels.

Aspect 4: The first device of any of Aspects 1-3, wherein the reservation signal is transmitted over a first subset of frequency resources of the less than all of the plurality of subchannels for the at least the portion of the time period, and wherein the processor and the memory are further configured to: transmit a second reservation signal within a second slot of the plurality of slots, the second reservation signal transmitted over a second subset of frequency resources of the less than all of the plurality of subchannels, the first subset of frequency resources corresponding to a different set of frequencies than the second subset of frequency resources.

Aspect 5: The first device of any of Aspects 1-4, wherein the reservation signal is transmitted over a subset of frequency resources of the less than all of the plurality of subchannels for the at least the portion of the time period, and wherein the processor and the memory are further configured to: transmit a second reservation signal within a second slot of the plurality of slots, the second reservation signal transmitted over the subset of frequency resources of the less than all of the plurality of subchannels.

Aspect 6: The first device of any of Aspects 1-5, wherein the reservation signal is transmitted over a first subset of frequency resources of the less than all of the plurality of subchannels during the at least the portion of the time period, and wherein the first subset of frequency resources consists of at least one resource element (RE) in each subchannel of the less than all of the plurality of subchannels.

Aspect 7: The first device of any of Aspects 1-6, wherein the processor and the memory are further configured to transmit a demodulation reference signal (DMRS) over a second subset of frequency resources of the less than all of the plurality of subchannels during the at least the portion of the time period, the second subset of frequency resources being separate from the first subset of frequency resources.

Aspect 8: The first device of any of Aspects 1-7, wherein the processor and the memory are further configured to apply an orthogonal cover code to the DMRS.

Aspect 9: The first device of any of Aspects 1-8, wherein the processor and the memory are further configured to store an indication of a characteristic of the reservation signal prior to transmission of the reservation signal, wherein the indication comprises one or more of an index or a mapping corresponding to the characteristic of the reservation signal.

Aspect 10: The first device of any of Aspects 1-9, wherein the at least one of the data signal or the reservation signal indicates to one or more other wireless devices that the frequency band is busy during the time period, wherein a plurality of devices wirelessly communicate over the frequency band during the time period.

Aspect 11: The first device of any of Aspects 1-10, wherein the reservation signal comprises a demodulation reference signal (DMRS).

Aspect 12: The first device of any of Aspects 1-11, further comprising dynamically selecting the one or more subchannels from the plurality of subchannels prior to transmitting the at least one of the data signal or the reservation signal.

Aspect 13: The first device of any of Aspects 1-12, wherein one of the plurality of subchannels is reserved for transmission of only reservation signals.

Aspect 14: The first device of any of Aspects 1-13, wherein the processor and the memory, being configured to transmit the at least one of the data signal or the reservation signal, are further configured to: transmit the reservation signal when the first device does not have data to transmit during the time period; and transmit the data signal when the first device has data to transmit during the time period.

Aspect 15: A first device of a plurality of devices, comprising: a memory; and a processor coupled to the memory, the processor and the memory configured to: receive wireless signaling within a time period over at least one subchannel of a plurality of subchannels in an unlicensed frequency band, the wireless signaling comprising: a reservation signal from a second device of the plurality of devices, the first device having an indication of a characteristic of the reservation signal stored thereon, the reservation signal reserving the unlicensed frequency band during the time period; and a data signal from a third device of the plurality of devices; and filter the reservation signal from the wireless signaling based on the characteristic of the reservation signal.

Aspect 16: The first device of Aspect 15, further comprising a transceiver, wherein the reservation signal is received, via the transceiver, by the first device over a set of wireless resources, and wherein the set of wireless resources comprises: (i) a first subset of resources over which the reservation signal is received, and (ii) a second subset of resources over which a demodulation reference signal (DMRS) is received.

Aspect 17: The first device of any of Aspects 15 and 16, wherein the data signal is received from the third device over the set of wireless resources other than the second subset of resources.

Aspect 18: The first device of any of Aspects 15-17, wherein: the data signal is received from the third device over the set of wireless resources, the data signal comprises a second DMRS received over the second subset of resources, the DMRS has a first orthogonal cover code applied, and the second DMRS has a second orthogonal cover code applied.

Aspect 19: The first device of any of Aspects 15-18, wherein the characteristic of the reservation signal comprises one or more of: the at least one subchannel over which the reservation signal is transmitted; a portion of the at least one subchannel over which the reservation signal is transmitted; a resource element (RE) occupied by the reservation signal, and one or more symbols within the RE; a waveform of the reservation signal; or a time and frequency pattern occupied by the reservation signal; and wherein the indication comprises one or more of an index or a mapping corresponding to the characteristic of the reservation signal.

Aspect 20: A method of wireless communication, comprising: sensing, by a first device, that an unlicensed frequency band is idle, the unlicensed frequency band consisting of a plurality of subchannels; and in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels.

Aspect 21: The method of Aspect 20, wherein the time period comprises a first slot of a plurality of slots of a time window.

Aspect 22: The method of any of Aspects 20 and 21, further comprising, for each of the plurality of slots other than the first slot, transmitting, by the first device, at least one of a corresponding data signal or a corresponding reservation signal during the entire duration of the slot over one or more corresponding subchannels of the plurality of subchannels.

Aspect 23: The method of any of Aspects 20-22, wherein the reservation signal is transmitted over a first subset of frequency resources of the less than all of the plurality of subchannels for the at least the portion of the time period, and further comprising: transmitting, by the first device, a second reservation signal within a second slot of the plurality of slots, the second reservation signal transmitted over a second subset of frequency resources of the less than all of the plurality of subchannels, the first subset of frequency resources corresponding to a different set of frequencies than the second subset of frequency resources.

Aspect 24: The method of any of Aspects 20-23, wherein the reservation signal is transmitted over a subset of frequency resources of the less than all of the plurality of subchannels for the at least the portion of the time period, and further comprising: transmitting, by the first device, a second reservation signal within a second slot of the plurality of slots, the second reservation signal transmitted over the subset of frequency resources of the less than all of the plurality of subchannels.

Aspect 25: The method of any of Aspects 20-24, wherein the reservation signal is transmitted over a first subset of frequency resources of the less than all of the plurality of subchannels during the at least the portion of the time period, and wherein the first subset of frequency resources consists of at least one resource element (RE) in each subchannel of the less than all of the plurality of subchannels.

Aspect 26: The method of any of Aspects 20-25, further comprising transmitting by the first device, a demodulation reference signal (DMRS) over a second subset of frequency resources of the less than all of the plurality of subchannels during the at least the portion of the time period, the second subset of frequency resources being separate from the first subset of frequency resources.

Aspect 27: The method of any of Aspects 20-26, further comprising applying an orthogonal cover code to the DMRS.

Aspect 28: The method of any of Aspects 20-27, further comprising storing, by the first device, an indication of a characteristic of the reservation signal prior to transmission of the reservation signal.

Aspect 29: The method of any of Aspects 20-28, wherein the at least one of the data signal or the reservation signal indicates to one or more other wireless devices that the frequency band is busy during the time period, wherein a plurality of devices wirelessly communicate over the frequency band during the time period.

Aspect 30: A method of wireless communication, comprising: receiving, by a first device of a plurality of devices, wireless signaling within a time period over at least one subchannel of a plurality of subchannels in an unlicensed frequency band, the wireless signaling comprising: a reservation signal from a second device of the plurality of devices, the first device storing an indication of a characteristic of the reservation signal, the reservation signal reserving the unlicensed frequency band during the time period; and a data signal from a third device of the plurality of devices; and filtering, by the first device, the reservation signal from the wireless signaling based on the characteristic of the reservation signal.

Aspect 31: A device comprising: one or more means for performing the method of one or more of Aspects 20-30.

Aspect 32: A non-transitory computer-readable storage medium having instructions stored thereon that when executed by a device, cause the device to perform the method of one or more of Aspects 20-30.

Aspect 33: A method of wireless communication, comprising: determining, by a first user equipment (UE) of a plurality of UEs, that a frequency band is idle; and in response to determining that the frequency band is idle, transmitting, by the first UE, a reservation signal within a first time period over multiple subchannels in the frequency band consisting of a plurality of subchannels, the reservation signal indicating to one or more other wireless devices that the frequency band is busy during the first time period, wherein the plurality of UEs wirelessly communicate over the frequency band during the first time period.

Aspect 34: The method of Aspect 33, further comprising transmitting, by the first UE, data over a first subchannel of the plurality of subchannels other than the multiple subchannels, the data transmitted within the first time period.

Aspect 35: The method of any of Aspects 33 and 34, further comprising refraining, by the first UE, from transmitting in a second time period, wherein the one or more other wireless devices wirelessly communicate over the frequency band during the second time period.

Aspect 36: The method of any of Aspects 33-35, wherein the first time period comprises a first slot of a plurality of slots of a first time window.

Aspect 37: The method of any of Aspects 33-36, further comprising: for each of the plurality of slots other than the first slot, transmitting, by the first UE, a corresponding reservation signal within a corresponding slot over corresponding multiple subchannels of the plurality of subchannels, the corresponding reservation signal indicating to the one or more other wireless devices that the frequency band is busy during the corresponding slot, wherein the plurality of UEs wirelessly communicate over the frequency band during the corresponding slot.

Aspect 38: The method of any of Aspects 33-37, wherein the reservation signal is transmitted over a first subset of frequency resources of the multiple subchannels, and further comprising: transmitting, by the first UE, a second reservation signal within a second slot of the plurality of slots, the second reservation signal transmitted over a second subset of frequency resources of the corresponding multiple subchannels, the first subset of frequency resources corresponding to a different set of frequencies than the second subset of frequency resources.

Aspect 39: The method of any of Aspects 33-38, wherein the reservation signal is transmitted over a first subset of frequency resources of the multiple subchannels, and further comprising: transmitting, by the first UE, a second reservation signal within a second slot of the plurality of slots, the second reservation signal transmitted over the first subset of frequency resources of the corresponding multiple subchannels.

Aspect 40: The method of any of Aspects 33-39, wherein each of the corresponding multiple subchannels corresponds to a different set of subchannels.

Aspect 41: The method of Aspect 40, wherein the multiple subchannels comprise the plurality of subchannels.

Aspect 42: The method of any of Aspects 33-40, wherein the reservation signal is transmitted over a first subset of frequency resources of the multiple subchannels during the first time period.

Aspect 43: The method of any of Aspects 33-42, wherein the first subset of frequency resources consists of one resource element in each subchannel of the multiple subchannels.

Aspect 44: The method of any of Aspects 33-43, further comprising transmitting by the first UE, a demodulation reference signal (DMRS) over a second subset of frequency resources of the plurality of subchannels during the first time period, the second subset of frequency resources being separate from the first subset of frequency resources.

Aspect 45: The method of any of Aspects 33-44, wherein the second subset of frequency resources during the first time period are reserved for transmission of DMRS by one or more reservation UEs of the plurality of UEs including the first UE.

Aspect 46: The method of any of Aspects 33-45, further comprising applying an orthogonal cover code to the DMRS, the orthogonal cover code being use for transmission of DMRS by one or more reservation UEs of the plurality of UEs including the first UE.

Aspect 47: The method of any of Aspects 33-46, wherein each of the plurality of UEs are preconfigured with a content of the reservation signal prior to transmission of the reservation signal by the first UE.

Aspect 48: The method of any of Aspects 33-47, wherein the reservation signal comprises a demodulation reference signal (DMRS).

Aspect 49: A user equipment (UE) comprising a memory and one or more processors configured to perform the method of one or more of Aspects 33-48.

Aspect 50: A user equipment (UE) comprising: one or more means for performing the method of one or more of Aspects 33-48.

Aspect 51: A non-transitory computer-readable storage medium having instructions stored thereon that when executed by a user equipment (UE), cause the UE to perform the method of one or more of Aspects 33-48.

Aspect 52: A method of wireless communication, comprising: receiving, by a first user equipment (UE) of a plurality of UEs, wireless signaling within a first time period over a subchannel of a plurality of subchannels in a frequency band, the wireless signal comprising: a reservation signal from a second UE of the plurality of UEs, the first UE preconfigured with a content of the reservation signal, the reservation signal indicating to one or more other wireless devices that the frequency band is busy during the first time period, wherein the plurality of UEs wirelessly communicate over the frequency band during the first time period; and a data signal from a third UE of the plurality of UEs; and filtering, by the first UE, the reservation signal from the wireless signaling using the content of the reservation signal.

Aspect 53: The method of Aspect 52, wherein the reservation signal is received by the first UE over a set of wireless resources, and wherein the set of wireless resources comprises: (i) a first subset of resources over which the content of the reservation signal is received, and (ii) a second subset of resources over which a demodulation reference signal (DMRS) is received.

Aspect 54: The method of any of Aspects 52 and 53, wherein the data signal is received from the third UE over the set of wireless resources other than the second subset of resources.

Aspect 55: The method of any of Aspects 52-54, wherein: the data signal is received from the third UE over the set of wireless resources, the data signal comprises a second DMRS received over the second subset of resources, and the DMRS has a first orthogonal cover code applied, and wherein the second DMRS has a second orthogonal cover code applied.

Aspect 56: A user equipment (UE) comprising a memory and one or more processors configured to perform the method of one or more of Aspects 52-55.

Aspect 57: A user equipment (UE) comprising: one or more means for performing the method of one or more of Aspects 52-55.

Aspect 58: A non-transitory computer-readable storage medium having instructions stored thereon that when executed by a user equipment (UE), cause the UE to perform the method of one or more of Aspects 52-55.

Aspect 59: A method of wireless communication, comprising: determining, by a first user equipment (UE) of a plurality of UEs, that a frequency band is idle; and in response to determining that the frequency band is idle, transmitting, by the first UE, one of a reservation signal or data within a first time period over a subchannel of a plurality of subchannels in the frequency band, the one of the reservation signal or the data indicating to one or more other wireless devices that the frequency band is busy within the first time period, wherein the plurality of UEs wirelessly communicate over the frequency band during the first time period.

Aspect 60: The method of Aspect 59, further comprising refraining, by the first UE, from transmitting in a second time period, wherein the one or more other wireless devices wirelessly communicate over the frequency band within the second time period.

Aspect 61: The method of any of Aspects 59 and 60, wherein the first time period comprises a slot of a plurality of slots of a first time window, and further comprising: for each of the plurality of slots other than the slot, transmitting, by the first UE, one of a corresponding reservation signal or corresponding data within a corresponding slot over at least one subchannel of the plurality of subchannels, the one of the corresponding reservation signal or the corresponding data indicating to the one or more other wireless devices that the frequency band is busy within the first time period, wherein the plurality of UEs wirelessly communicate over the frequency band within the corresponding slot.

Aspect 62: The method of any of Aspects 59-61, wherein one of the plurality of subchannels is reserved for transmission of only reservation signals by one or more reservation UEs including the first UE.

Aspect 63: The method of any of Aspects 59-62, wherein transmitting the one of the reservation signal or the data comprises: determining whether the first UE has data to transmit; and if the first UE has data to transmit, transmitting the data within the first time period; otherwise, transmitting the reservation signal within the first time period.

Aspect 64: The method of any of Aspects 59-63, further comprising dynamically selecting the subchannel from the plurality of subchannels.

Aspect 65: The method of any of Aspects 59-64, wherein: when each of the plurality of subchannels is reserved by any of the plurality of UEs other than the first UE, the subchannel has a lowest measured power among the plurality of subchannels, and when at least one of the plurality of subchannels is unreserved by the plurality of UEs other than the first UE, the subchannel is one of the at least one of the plurality of subchannels.

Aspect 66: The method of any of Aspects 59-65, wherein the frequency band comprises a sidelink in an unlicensed spectrum.

Aspect 67: The method of Aspect 66, wherein the sidelink is used for vehicle to everything communication.

Aspect 68: The method of any of Aspects 59-67, wherein the first time period is one of a plurality of time periods of a first time window that occurs periodically.

Aspect 69: A user equipment (UE) comprising a memory and one or more processors configured to perform the method of one or more of Aspects 59-68.

Aspect 70: A user equipment (UE) comprising: one or more means for performing the method of one or more of Aspects 59-68.

Aspect 71: 1A non-transitory computer-readable storage medium having instructions stored thereon that when executed by a user equipment (UE), cause the UE to perform the method of one or more of Aspects 59-68.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

Within the present document, the term “user equipment (UE)” or “CV2X device” broadly refers to a diverse array of devices and technologies. UEs and CV2X devices may include a number of hardware structural components sized, shaped, and arranged to help in communication; such components can include antennas, antenna arrays, RF chains, amplifiers, one or more processors, etc. electrically coupled to each other. For example, some non-limiting examples of a UE or CV2X device include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A UE or CV2X device may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A UE or CV2X device may additionally be a digital home or smart home device such as a home audio, video, and/or multimedia device, an appliance, a vending machine, intelligent lighting, a home security system, a smart meter, etc. A UE or CV2X device may additionally be a smart energy device, a security device, a solar panel or solar array, a municipal infrastructure device (e.g., a smart grid, public WiFi, etc.), an industrial automation and enterprise device, a logistics controller, agricultural equipment, military defense equipment: vehicles, aircraft, ships, and weaponry, etc. Still further, a UE or CV2X device may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise a non-transitory computer-readable medium (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 12, 13, 15, 17, and 18.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A first device, comprising:
a memory; and
a processor coupled to the memory, the processor and the memory configured to:
sense that an unlicensed frequency band is idle, the unlicensed frequency band consisting of a plurality of subchannels; and
in response to sensing that the unlicensed frequency band is idle, transmit at least one of a data signal or a reservation signal during an entire duration of a time period over one or more subchannels of the plurality of subchannels, at least one of the data signal or the reservation signal reserving the unlicensed frequency band during the time period, wherein the transmission of the at least one of the data signal or the reservation signal during the time period comprises transmission of the reservation signal for at least a portion of the time period over less than all of the plurality of subchannels.

2. The first device of claim 1, wherein the time period comprises a first slot of a plurality of slots of a time window.

3. The first device of claim 2, further comprising a transceiver, wherein the processor, the memory, and the transceiver are further configured to transmit, for each of the plurality of slots other than the first slot, at least one of a corresponding data signal or a corresponding reservation signal during the entire duration of the slot over one or more corresponding subchannels of the plurality of subchannels.

4. The first device of claim 2, wherein the reservation signal is transmitted over a first subset of frequency resources of the less than all of the plurality of subchannels for the at least the portion of the time period, and wherein the processor and the memory are further configured to:
transmit a second reservation signal within a second slot of the plurality of slots, the second reservation signal transmitted over a second subset of frequency resources of the less than all of the plurality of subchannels, the first subset of frequency resources corresponding to a different set of frequencies than the second subset of frequency resources.

5. The first device of claim 2, wherein the reservation signal is transmitted over a subset of frequency resources of the less than all of the plurality of subchannels for the at least the portion of the time period, and wherein the processor and the memory are further configured to:
transmit a second reservation signal within a second slot of the plurality of slots, the second reservation signal transmitted over the subset of frequency resources of the less than all of the plurality of subchannels.

6. The first device of claim 1, wherein the reservation signal is transmitted over a first subset of frequency resources of the less than all of the plurality of subchannels during the at least the portion of the time period, and wherein the first subset of frequency resources consists of at least one resource element (RE) in each subchannel of the less than all of the plurality of subchannels.

7. The first device of claim 6, wherein the processor and the memory are further configured to transmit a demodulation reference signal (DMRS) over a second subset of frequency resources of the less than all of the plurality of subchannels during the at least the portion of the time period, the second subset of frequency resources being separate from the first subset of frequency resources.

8. The first device of claim 7, wherein the processor and the memory are further configured to apply an orthogonal cover code to the DMRS.

9. The first device of claim 1, wherein the processor and the memory are further configured to store an indication of a characteristic of the reservation signal prior to transmission of the reservation signal.

10. The first device of claim 1, wherein the at least one of the data signal or the reservation signal indicates to one or more other wireless devices that the frequency band is busy during the time period, wherein a plurality of devices wirelessly communicate over the frequency band during the time period.

11. The first device of claim 1, wherein the reservation signal comprises a demodulation reference signal (DMRS).

12. The first device of claim 1, further comprising dynamically selecting the one or more subchannels from the plurality of subchannels prior to transmitting the at least one of the data signal or the reservation signal.

13. The first device of claim 1, wherein one of the plurality of subchannels is reserved for transmission of only reservation signals.

14. The first device of claim 1, wherein the processor and the memory, being configured to transmit the at least one of the data signal or the reservation signal, are further configured to:
transmit the reservation signal when the first device does not have data to transmit during the time period; and
transmit the data signal when the first device has data to transmit during the time period.

15. A first device of a plurality of devices, comprising:
a memory; and
a processor coupled to the memory, the processor and the memory configured to:
receive wireless signaling within a time period over at least one subchannel of a plurality of subchannels in an unlicensed frequency band, the wireless signaling comprising:
a reservation signal from a second device of the plurality of devices,
the first device having an indication of a characteristic of the reservation signal stored thereon, the reservation signal reserving the unlicensed frequency band during the time period; and
a data signal from a third device of the plurality of devices; and
filter the reservation signal from the wireless signaling based on the characteristic of the reservation signal.

16. The first device of claim 15, further comprising a transceiver, wherein the reservation signal is received, via the transceiver, by the first device over a set of wireless resources, and wherein the set of wireless resources comprises: (i) a first subset of resources over which the reservation signal is received, and (ii) a second subset of resources over which a demodulation reference signal (DMRS) is received.

17. The first device of claim 16, wherein the data signal is received from the third device over the set of wireless resources other than the second subset of resources.

18. The first device of claim 16, wherein:
the data signal is received from the third device over the set of wireless resources,
the data signal comprises a second DMRS received over the second subset of resources,
the DMRS has a first orthogonal cover code applied, and
the second DMRS has a second orthogonal cover code applied.

19. The first device of claim 15, wherein the characteristic of the reservation signal comprises one or more of:
the at least one subchannel over which the reservation signal is transmitted;
a portion of the at least one subchannel over which the reservation signal is transmitted;
a resource element (RE) occupied by the reservation signal, and one or more symbols within the RE;
a waveform of the reservation signal; or
a time and frequency pattern occupied by the reservation signal.

20. A method of wireless communication, comprising:
sensing, by a first device, that an unlicensed frequency band is idle, the unlicensed frequency band consisting of a plurality of subchannels; and
in response to sensing that the unlicensed frequency band is idle, transmitting, by the first device, at least one of a data signal or a reservation signal during an entire duration of a time period over one or more subchannels of the plurality of subchannels, the at least one of the data signal or the reservation signal reserving the unlicensed frequency band during the time period, wherein transmitting the at least one of the data signal or the reservation signal during the entire duration of the time period comprises transmitting the reservation signal for at least a portion of the time period over less than all of the plurality of subchannels.

21. The method of claim 20, wherein the time period comprises a first slot of a plurality of slots of a time window.

22. The method of claim 21, further comprising, for each of the plurality of slots other than the first slot, transmitting, by the first device, at least one of a corresponding data signal or a corresponding reservation signal during the entire duration of the slot over one or more corresponding subchannels of the plurality of subchannels.

23. The method of claim 21, wherein the reservation signal is transmitted over a first subset of frequency resources of the less than all of the plurality of subchannels for the at least the portion of the time period, and further comprising:
transmitting, by the first device, a second reservation signal within a second slot of the plurality of slots, the second reservation signal transmitted over a second subset of frequency resources of the less than all of the plurality of subchannels, the first subset of frequency resources corresponding to a different set of frequencies than the second subset of frequency resources.

24. The method of claim 21, wherein the reservation signal is transmitted over a subset of frequency resources of the less than all of the plurality of subchannels for the at least the portion of the time period, and further comprising:
transmitting, by the first device, a second reservation signal within a second slot of the plurality of slots, the second reservation signal transmitted over the subset of frequency resources of the less than all of the plurality of subchannels.

25. The method of claim 20, wherein the reservation signal is transmitted over a first subset of frequency resources of the less than all of the plurality of subchannels during the at least the portion of the time period, and wherein the first subset of frequency resources consists of at least one resource element (RE) in each subchannel of the less than all of the plurality of subchannels.

26. The method of claim 25, further comprising transmitting by the first device, a demodulation reference signal (DMRS) over a second subset of frequency resources of the less than all of the plurality of subchannels during the at least the portion of the time period, the second subset of frequency resources being separate from the first subset of frequency resources.

27. The method of claim 26, further comprising applying an orthogonal cover code to the DMRS.

28. The method of claim 20, further comprising storing, by the first device, an indication of a characteristic of the reservation signal prior to transmission of the reservation signal.

29. The method of claim 20, wherein the at least one of the data signal or the reservation signal indicates to one or more other wireless devices that the frequency band is busy during the time period, wherein a plurality of devices wirelessly communicate over the frequency band during the time period.

30. A method of wireless communication, comprising:
receiving, by a first device of a plurality of devices, wireless signaling within a time period over at least one subchannel of a plurality of subchannels in an unlicensed frequency band, the wireless signaling comprising:
a reservation signal from a second device of the plurality of devices, the first device storing an indication of a characteristic of the reservation signal, the reservation signal reserving the unlicensed frequency band during the time period; and
a data signal from a third device of the plurality of devices; and
filtering, by the first device, the reservation signal from the wireless signaling based on the characteristic of the reservation signal.
